(19) United States
(12) Patent Application Publication
(10) Pub. No.: US 2020/0186985 A1
(43) Pub. Date: Jun. 11, 2020

(54) METHOD AND APPARATUS FOR PAIRING IOT DEVICES AND IOT SERVICE IN HETEROGENEOUS IOT ECOSYSTEM

(71) Applicant: Samsung Electronics Co., Ltd., Suwon-si (KR)

(72) Inventors: Ida Bagus Putu Peradnya DINATA, Jakarta (ID); Ganda Kusuma UTAMA, Jakarta (ID); Nizam RAHMAN, Jakarta (ID); Hadi PRAWIRATAMA, Jakarta (ID); Yanuar RAHMAN, Jakarta (ID)

(21) Appl. No.: 16/707,521

(22) Filed: Dec. 9, 2019

(30) Foreign Application Priority Data
Dec. 7, 2018 (ID) PID201810192

(51) Int. Cl. H04W 4/70; H04L 12/24; H04W 76/10; G06F 9/54; H04W 12/06

(52) U.S. Cl. CPC H04W 4/70; H04L 41/0809; H04W 12/06; G06F 9/547; H04W 76/10

(57) ABSTRACT

An electronic apparatus and method are provided. An end-to-end automatic interconnection of heterogeneous Internet of things (IoT) systems automates both Cloud-to-Cloud (C2C) (Primary IoT Service to External IoT Services) and Device-to-Cloud (D2C) (IoT Devices to IoT Services) pairing process, utilizing IoT service information with visual and/or radio tag information, available in IoT devices and services.

### CROSS-REFERENCE TO RELATED APPLICATION(S)

This application is based on and claims priority under 35 U.S.C. § 119 of an Indonesian patent application number PID201810192, filed on Dec. 7, 2018, in the Indonesia Patent Office, the disclosure of which is incorporated by reference herein in its entirety.

### BACKGROUND

### 1. Field

The disclosure relates to method and apparatus for simplifying the pairing process of Internet of things (IoT) devices and IoT services in heterogeneous IoT Ecosystem. More particularly, the disclosure relates to the pairing process including how user to perform cloud-to-cloud (C2C) pairing between their primary IoT services and external IoT services and how to perform device-to-cloud (D2C) pairing between their IoT devices to the IoT services.

### 2. Description of Related Art

There are no inventions discussing methods on how to enable a user to automate pairing processes using a heterogeneous IoT device from various vendors. Currently, users must do a series of manual configuration on each of the IoT system entities to do such simple as turn-on and turn-off control across different vendors.

U.S. Pat. No. 9,977,415 ('415 patent) discusses the system and method to implement a virtual IoT hub and device. The '415 patent focuses on how the system works to support multiple IoT hubs and devices. Meanwhile, the disclosure herein discloses how (from user interface (UI), process, and flow) the users can easily pair their IoT device to the IoT service.

US Publication 2015-0058445 ('445 USP) discusses the system and method to create an abstraction of IoT service and device. '445 USP focuses on how to create abstraction in the IoT service to support many IoT devices. The disclosure herein discloses the pairing procedure (from UI, process, and flow) so that the users can easily pair their IoT things with the IoT service.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an end-to-end automatic interconnection of heterogeneous IoT systems, which may automate both C2C (primary IoT service to external IoT services) and D2C (IoT devices to IoT services) pairing process.

Additional aspects will be set forth in part in the description which follows and, in part, will be apparent from the description, or may be learned by practice of the presented embodiments.

In accordance with an aspect of the disclosure, an electronic apparatus or device is provided. The electronic device may include a memory configured to store one or more instructions, and at least one processor configured to execute the one or more instructions to receive a pairing request to execute at least one of cloud-to-cloud (C2C) pairing or device-to-cloud (D2C) pairing, obtain pairing information comprising at least one of information about an external IoT service or information about an IoT device based on the pairing request, generate a pairing procedure model based on the pairing information and the pairing request, and execute the at least one of the C2C pairing between a primary IoT service and the external IoT service or the D2C pairing between the IoT service and the IoT device based on the pairing procedure.

In accordance with another aspect of the disclosure, the at least one processor may be further configured to obtain a user selection of the external IoT service, perform user authentication of the external IoT service to authorize the primary IoT service to access and use an Application Program Interface (API) of the external IoT service based on the pairing request, execute the C2C pairing process in the primary IoT service and the external IoT service, and execute the API of the external IoT service from the primary IoT service, wherein the pairing request comprises information about the external IoT service to execute the Cloud-to-Cloud (C2C) pairing.

In accordance with another aspect of the disclosure, the at least one processor may be further configured to obtain a user selection of the IoT device, activate a pairing state in the IoT device, wherein the IoT device can be paired with at least one of supported IoT service or supported IoT hub, obtain the pairing information including information about at least one the IoT service selected by a user, execute the D2C pairing process between the IoT device and the at least one IoT service, and execute at least one function of the IoT device from the at least one IoT service, wherein the pairing request include information about the IoT device to execute the Device-to-Cloud (D2C) pairing, and wherein the at least one IoT service supports the D2C pairing with the IoT device.

In accordance with another aspect of the disclosure, the at least one processor is further configured to obtain information of an IoT hub selected by a user of the electronic apparatus, transmit the pairing request of the D2C pairing to the IoT hub based on the information about the IoT hub, receive a pairing response of the D2C pairing from the IoT hub according to the pairing request, and execute the D2C pairing process via the IoT hub selected by the user.

In accordance with another aspect of the disclosure, at least one processor is further configured to request a C2C module to start the C2C pairing or a D2C module to start the D2C pairing based on execution of the pairing procedure, wherein the pairing process comprises at least one of pairing between the IoT device with the primary IoT service, pairing between the IoT device with paired external IoT service, pairing between the IoT device with unpaired external IoT service, or pairing between IoT devices with IoT service via IoT hub.

In accordance with another aspect of the disclosure, the pairing process may include pairing the IoT device with the IoT service, wherein the at least one processor is further configured to request the D2C pairing to an IoT application, obtain TAG information by scanning TAG of the IoT device, and transmit the pairing request and the TAG information to the IoT service via an IoT application.

In accordance with another aspect of the disclosure, the pairing process may include automatic C2C pairing or automatic D2C pairing using a preset configuration, wherein at the least one processor is further configured to generate a custom pairing procedure comprising user-defined C2C or D2C pairing procedure, obtain the pairing request to enable reading the custom pairing procedure, and load and execute the custom pairing procedure in the primary IoT service.

In accordance with another aspect of the disclosure, the pairing process may include a flexible IoT service switching, wherein the at least one processor is further configured to obtain user selection information comprising device information about the IoT device selected to change from previous IoT service and service information about the IoT service selected as new target to pair with the selected IoT device, un-pair the previous IoT service with the IoT device, enable the pairing state of the IoT device, and perform the D2C pairing between the IoT device and the selected IoT service.

In accordance with another aspect of the disclosure, the electronic device is provided. The electronic device includes a manager configured to receive pairing request, manage an automatic pairing process in a submodule, and return an automatic pairing process response, a loader configured to collect the data comprising at least one of tag information, IoT device information, IoT service information, information about user preference, or information about custom pairing procedure, a pre-processor configured to filter unnecessary data from the data from the loader, transform the data, and parse the data to be understood by a generator, the generator configured to generate model of pairing procedure based on the pre-processed data from the pre-processor, and an executor configured to execute and give instruction to perform an action based on the pairing procedure model from the generator.

In accordance with another aspect of the disclosure, the tag information may include key information to know an identity of the device embedded in the tag of the device, which is useful to retrieve IoT device information from IoT information service. In addition, the IoT device information may include detail information including information of the at least one of identification of IoT device, capabilities of the IoT device, protocols of the D2C pairing, a supported IoT service, or an IoT device pairing procedure. The IoT service information may include the detail information including information about the at least one of identification of IoT service, capabilities of the IoT service, protocols of the C2C pairing or the D2C pairing, an API, a supported external IoT service, a security procedure, or an IoT service pairing procedure. The information about user preference may include information set by user including at least one of a user device, a user service, identification of user, security, or network configurations.

In accordance with another aspect of the disclosure, a method is provided. The method includes obtaining pairing request to do at least one of cloud-to-cloud (C2C) pairing or device-to-cloud (D2C) pairing, receiving a pairing request to execute at least one of cloud-to-cloud (C2C) pairing or device-to-cloud (D2C) pairing, obtaining pairing information comprising at least one of information about an external IoT service or information about an IoT device based on the pairing request, generating a pairing procedure based on the pairing information and the pairing request, and executing at least one of the C2C pairing between a primary IoT service and the external IoT service or the D2C pairing between the IoT service and the IoT device based on the pairing procedure.

In accordance with another aspect of the disclosure, a computer program product is provided. The computer program product comprises a non-transitory computer-readable recording medium having recorded thereon a plurality of instructions, which when executed by the at least one processor, causes the at least one processor to obtain pairing request to do at least one of cloud-to-cloud (C2C) pairing or device-to-cloud (D2C) pairing, obtain pairing information comprising at least one of information about an external IoT service to pair with a primary IoT service or information about an IoT device to pair with the primary IoT service based on the pairing request, generate a pairing procedure model based on pairing information and pairing request, and execute at least one of C2C pairing process between the primary IoT service and the external IoT service or D2C pairing process between the primary IoT service and the IoT device based on the pairing procedure.

In accordance with another aspect of the disclosure, the system and method are provided. The system and method include an end-to-end automatic interconnection of IoT devices and systems within heterogeneous IoT ecosystem, by automating both a cloud-to-cloud (C2C) pairing process which is a paring process between a primary IoT service and external IoT services, and device-to-cloud (D2C) which is a pairing process between IoT devices and IoT services. The disclosure proposes an automatic pairing mechanism to perform sensing and actuating of available IoT devices and IoT services within an IoT ecosystem, through an automatic pairing module (APM) where pairing procedure is generated and then executed to perform the pairing procedure, utilizing the IoT information service where the IoT information (including at least one of the tag information, the IoT device information, or the IoT service information) is being created, saved, managed and retrieved. The automatic pairing module (APM) in the system may include the following entities: a manager configured to receive a pairing request, manage the APM process in the submodule, and return the APM process response to the requester; a loader configured to collect the data from many sources including IoT information service and the storage, further collect the data including at least one of tag information, including the key information to know the identity of the device embedded in the tag of the device, which is useful to retrieve the IoT device information from the IoT information service, the IoT device information, the detail information of the IoT device including ID, capabilities, protocols, supported IoT service, and IoT device pairing procedure, the IoT service information, the detail information of the IoT device including ID, capabilities, protocols, API, supported external IoT service, security procedure, and IoT service pairing procedure, or user preference which is information, set by user, including information of the device, the service, the user, the security, the network configurations, the custom pairing procedure, and the custom procedure set by user to pair C2C or D2C in specific cases; pre-processor, that may filter the unnecessary data from the collected data from loader, transform the filtered data, and parse the filtered data to be understood by a generator; the generator, that may generate a model of the pairing procedure based on the pre-processed data from the pre-processor; executor, that may execute and then give instruction to corresponding a module in the IoT service to do action based on the pairing procedure model from the generator.

The IoT information service in the system may include the following entities: a manager, which will receive a request, manage the request including an IoT information request or a registration, and return the response to requester; a storage, where all the IoT information including the tag information, the IoT device information, and the IoT service information may be stored, retrieve, and managed; a parser, where the tag information may be parsed to retrieve the key information so can be used for requesting the IoT device information from the storage; a generator, which may generate tag information based on the received IoT device information.

In accordance with another aspect of the disclosure, the system may automate pairing mechanism through the automatic pairing mechanism (APM) further including the following steps of receiving a request from a user or system to do cloud-to-cloud (C2C) or device-to-cloud (D2C) pairing, acquiring the necessary information from the IoT information service and a storage to the APM, based on the receiving pairing request, pre-processing the acquired information to take off the unused data and parse and transform the data to be understandable by the generator based on the received pairing request, generating the pairing procedure model in the APM based on the pre-processed information and the pairing request, and executing the pairing procedure model to the selected modules based on the generated pairing procedure model.

In accordance with another aspect of the disclosure, the system may further include the following steps to enable Cloud-to-Cloud (C2C) pairing mechanism, by receiving request from a user or systems to perform C2C pairing. The system may include the following steps executing the APM to start the automatic pairing procedure based on the pairing request; execute user authentication of the selected external IoT service to authorize the primary IoT service to access and use the API of the external IoT service; starting the pairing process in the primary IoT service side and the pairing process in the external IoT service side; and confirming the pairing process by calling the API of the external IoT service from the primary IoT service.

In accordance with another aspect of the disclosure, the system may further include the following steps to enable the device-to-cloud (D2C) pairing mechanism, by enabling the pairing state in the IoT device which make the IoT device be paired with the IoT service or the IoT hub device, receiving a request from a user or a system to do the D2C pairing, and selecting the IoT device that the user wants to pair with the IoT service. Then the APM may request the IoT device information to the IoT information service to get the list of the supported IoT service or the IoT hub. The system may further include the following steps by showing the list of the IoT service supported by the selected IoT device based on the IoT device information to the IoT application, and selecting the IoT service that the user wants to be paired with IoT device based on the IoT device information. Then the APM may request the IoT service information to the IoT information service to obtain a procedure to pair the IoT device with the selected IoT service. The system may further include the following steps by executing the APM to start the automatic pairing procedure based on the pairing request, the IoT service information, and the IoT device information, starting the pairing process between the IoT device and IoT service, and confirming the pairing process by executing the function inside the IoT device from the IoT service.

In accordance with another aspect of the disclosure, the system may employ the IoT information service with their availability and publicity categorized by IoT information service Tier 1 privately available and used by an IoT service, and the IoT information service Tier 2 publicly available and used by multiple IoT services.

In accordance with another aspect of the disclosure, the system further comprises the following steps to enable the IoT device registration to the selected IoT information service, by requesting the registration of the IoT device to the IoT information service, and uploading the IoT device information to complete the IoT device registration process. Additionally, at least one IoT vendor can also upload their existing tag information for the device if available. The method may include generating the tag information including the key information by the generator from the uploaded IoT device information if the IoT vendor does not upload the tag information during the registration process, reading and parsing the tag information by the parser to get the key information if the IoT vendor uploads the tag information during the registration process, saving the IoT device information with the key information from the tag information to the storage, receiving the registration response, including the generated tag information, and implementing the tag information to the tag that will be attached on the IoT device.

In accordance with another aspect of the disclosure, the system may further comprise the following steps to enable the IoT service to retrieve the IoT device information, by requesting the retrieval of the IoT device information to the IoT information service, uploading the tag information to complete the IoT device information request to the IoT information service, parsing the tag information to get the key information to query the IoT device information in the storage, acquiring the IoT device information from the storage, and receiving the IoT device information as the result of the IoT device information request.

According to an embodiment, the automatic pairing module (APM) may request the cloud-to-cloud (C2C) module and/or the device-to-cloud (D2C) module to start the pairing process according to the execution of the pairing procedure. The pairing process between the IoT device and the IoT service may be further comprised of pairing between the IoT device with a primary IoT service done with the APM to instruct the D2C module inside the primary IoT service to perform the pairing process with the IoT device, pairing between the IoT device and the paired external IoT service done with the APM to instruct the C2C module inside the primary IoT service to call the API of the external IoT service which makes an external IoT service to perform the pairing with the IoT application, pairing between the IoT device and the unpaired external IoT service done by the APM to instruct the C2C module inside the primary IoT service to start the C2C pairing between the primary IoT service and the external IoT service, and then continued with pairing between the IoT device and the external IoT service, and pairing between the IoT devices and the IoT service via IoT hub done by the APM to instruct the D2C module to call the selected IoT hub as a bridge to pair the IoT device and the primary IoT service, or to instruct the C2C module to call the IoT hub paired at external IoT service as a bridge to pair the IoT device with the external IoT service.

According to an embodiment, the system may enhance capabilities of the IoT device, an automatic pairing and/or an un-pairing process, and enable a flexible switch between various IoT devices and service. The system may further include the following procedures: pairing IoT devices with IoT service, wherein a user performs the following steps, by requesting the D2C pairing in the IoT application, scanning the tag of the IoT device using a tag reader in the smartphone or an extended TAG reader connected to smartphone, receiving tag information from the tag reader or the extended tag reader to the IoT application, and sending the pairing request and tag information to the IoT service via the IoT application; automatically the C2C or D2C Pairing in the IoT ecosystem using the preset configuration, wherein the user performs the following steps, by building the custom pairing procedure including a user-defined C2C or D2C pairing procedure, starting the pairing C2C or D2C process, configuring the pairing request to enable reading the custom pairing procedure, and loading and executing the custom pairing procedure to the APM in the primary IoT service performing the C2C or D2C pairing process; flexible IoT service switching between the IoT devices and the IoT services, wherein user or system may perform the following steps, by selecting the IoT device that user would like to change from the paired IoT service, selecting the IoT service that user would like to select a new target to pair with the selected IoT device, unpairing the previous IoT service paired with the IoT device and then enable the pairing state of the IoT device, and performing the D2C pairing between the IoT device and the selected IoT service, enhancing functionality and capability of the IoT device paired with primary IoT service by doing the C2C pairing between the primary IoT service and the external IoT services compatible for the IoT device. The system may include obtaining the selected IoT device that the user wants to enhance its capability, scanning the list of compatible external IoT services for the selected IoT device based on the IoT device information, and showing the list to the IoT application. The system may include obtaining user selecting the external IoT services to be paired with the primary IoT service for the selected IoT device, executing the C2C pairing to the selected external IoT services with the primary IoT service, and updating capability and functionality of the selected IoT Device based on the selected external IoT service.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view of an IoT ecosystem to support a C2C and/or D2C paring mechanism according to an embodiment of the disclosure;

FIG. 2A illustrates an example of the C2C pairing process from the user perspective according to an embodiment of the disclosure;

FIG. 2B illustrates an example of a result of the C2C pairing process from the user perspective according to an embodiment of the disclosure;

FIG. 3A illustrates an example of the D2C pairing process from the user perspective according to an embodiment of the disclosure;

FIG. 3B illustrates an example of a result of the D2C pairing process from the user perspective according to an embodiment of the disclosure;

FIG. 3C illustrates examples of use-cases of the D2C pairing process according to an embodiment of the disclosure;

FIG. 4A illustrates a process of flexible IoT service switching, which illustrates the flow of an IoT application when a user wants to switch their IoT services according to an embodiment of the disclosure;

FIG. 4B illustrates a result of the process of the flexible IoT service switching according to an embodiment of the disclosure;

FIG. 5 illustrates a process of a mass pairing of the IoT devices using the APM and custom pairing procedure according to an embodiment of the disclosure;

FIG. 6 illustrates a sample scenario on how to enhance functionality and capability of the IoT device paired with the primary IoT service using the external IoT services according to an embodiment of the disclosure;

FIG. 7 illustrates a system and data required to enable the C2C pairing in the IoT ecosystem according to an embodiment of the disclosure;

FIG. 8A is a flowchart of the C2C pairing between the primary IoT service and the external IoT service according to an embodiment of the disclosure;

FIG. 8B is a flowchart of the C2C unpairing process between the primary IoT service and the external IoT service according to an embodiment of the disclosure;

FIG. 9 illustrates the pairing and unpairing process of the C2C module according to an embodiment of the disclosure;

FIG. 10 illustrates a sequence diagram of the C2C pairing according to an embodiment of the disclosure;

FIG. 11 illustrates an overall mechanism on how the IoT application reads the tag in the IoT device according to an embodiment of the disclosure;

FIG. 12 is a block diagram of an IoT system to support the D2C pairing process according to an embodiment of the disclosure;

FIG. 13 is a flowchart illustrating the detailed process and the system to support the device to cloud (D2C) IoT pairing mechanism according to an embodiment of the disclosure;

FIGS. 14A and FIG. 14B illustrate of the D2C pairing by scanning the tag which shows a flow of the user interface during the D2C pairing process according to various embodiments of the disclosure;

FIG. 15 illustrates examples of a sequence Diagram of the D2C Pairing according to an embodiment of the disclosure;

FIG. 16 a detailed sequence diagram of the D2C pairing process for the unpaired external IoT service, according to an embodiment of the disclosure according to an embodiment of the disclosure;

FIG. 17 a detailed sequence diagram of the D2C pairing process for the paired external IoT service according to an embodiment of the disclosure;

FIG. 18 illustrates a detailed sequence diagram of the D2C pairing process between the IoT device and the primary IoT service via the hub according to an embodiment of the disclosure;

FIG. 19 a detailed sequence diagram of the D2C pairing process between the IoT device and the primary IoT service via the hub according to an embodiment of the disclosure;

FIG. 20 is a block diagram illustrating the IoT information service system and the tiers in the IoT ecosystem according to an embodiment of the disclosure;

FIG. 21A is a flowchart of obtaining the IoT device information according to an embodiment of the disclosure;

FIG. 21B is a flowchart of registering the IoT device information according to an embodiment of the disclosure;

FIG. 22A is a block diagram of a process of registering the IoT device information when the tag information already exists according to an embodiment of the disclosure;

FIG. 22B is a block diagram of a process of registering the IoT device information without the tag information according to an embodiment of the disclosure;

FIG. 22C is a block diagram of a process to obtain the IoT Device Info according to an embodiment of the disclosure;

FIG. 23 illustrates a block diagram illustrating the APM system to perform the D2C or C2C pairing to automate the pairing process between the IoT device and the IoT service according to an embodiment of the disclosure;

FIG. 24 is a flowchart of the automatic pairing flow to perform the D2C or C2C pairing according to an embodiment of the disclosure; and

FIG. 25 is a block diagram of an electronic apparatus according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It may be noted that to the extent possible, like reference numerals have been used to represent like elements in the drawings. Further, those of ordinary skill in the art will appreciate that elements in the drawings are illustrated for simplicity and may not have been necessarily drawn to scale. For example, the dimensions of some of the elements in the drawings may be exaggerated relative to other elements to help to improve understanding of aspects of the embodiments. Furthermore, the one or more elements may have been represented in the drawings by various symbols, and the drawings may show only those specific details that are pertinent to understanding the embodiments of the disclosure so as not to obscure the drawings with details that will be readily apparent to those of ordinary skill in the art having benefit of the description herein.

It is to be understood that the singular forms “a,” “an,” and “the” include plural referents unless the context clearly dictates otherwise. Thus, for example, reference to “a component surface” includes reference to one or more of such surfaces. Additionally, expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Moreover, various functions described below may be implemented or supported by one or more computer programs, each of which may be formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

The term “unit”, “manager”, “engine”, or “device” may refer to a unit which processes at least one function or operation and may be implemented by hardware, software, or a combination of hardware and software.

As more IoT devices are introduced to the market, consumers are provided with various options to utilize the IoT devices. The tendency of consumers to use different IoT products that fit their needs (price, features, etc.) will cause the consumers to purchase IoT products from different vendors. On the other hand, the fragmentation in the IoT industry such as “No Global Standard” will lead the IoT vendors to build their own proprietary IoT services (cloud) and the IoT standard for their own IoT devices. This implication will make the consumer to register multiple accounts of the IoT services for the different IoT vendors and make consumers pair and manage their heterogeneous IoT devices and the IoT services by themselves.

To address arising issues in the heterogeneous IoT devices and IoT services, the apparatus and methods may simplify the pairing process of the IoT device and service. The disclosure will implement user authentication for the C2C pairing, the tag based on the pairing for D2C, the apparatus and the method to obtain device information from the scanned TAG, and the apparatus and the method to execute the pairing process of C2C or D2C.

The disclosure will bring advantages for the users such as: 1) easy pairing; The disclosure may allow pairing the IoT device with the IoT service automatically and simply using a tag-based identifier (an image tag or a radio tag) to identify the IoT devices, regardless of their vendor or standard; 2) single application pairing; Instead of installing IoT applications for every IoT vendors, the disclosure may allow users to pair their IoT devices from different vendors and connect the IoT devices to the external IoT services using the C2C mechanism only from a single IoT application; and 3) flexible pairing; user may enjoy the flexibility of choosing compatible IoT service to which he/she wants to connect his/her IoT device without difficulty.

Embodiments of the disclosure herein may have two main features. First, the embodiment herein will enable a seamless pairing process of the IoT devices and the IoT services in the heterogeneous IoT ecosystem by building an automatic pairing module (APM) which automates the pairing process seamlessly using the IoT information, the user preference, and/or the custom pairing procedure and utilizing the IoT information service which provides the IoT device information and the IoT service information for enabling the automatic pairing process. Second, the embodiment herein will include a cloud-to-cloud (C2C) pairing between the primary IoT service and the external IoT service, and a device-to-cloud (D2C) pairing between the IoT devices and the IoT services by applying C2C pairing via user authentication to perform a pairing process of C2C as simple and user-friendly and applying a D2C pairing via a tag (visual or radio) identifier to perform a process of D2C pairing seamlessly and automatically. To perform seamless and automatic pairing, an embodiment herein may disclose a system to store and retrieve the IoT device information based on the tag information, and a system that can generate and execute a pairing process automatically based on the IoT device information provided by the IoT information service.

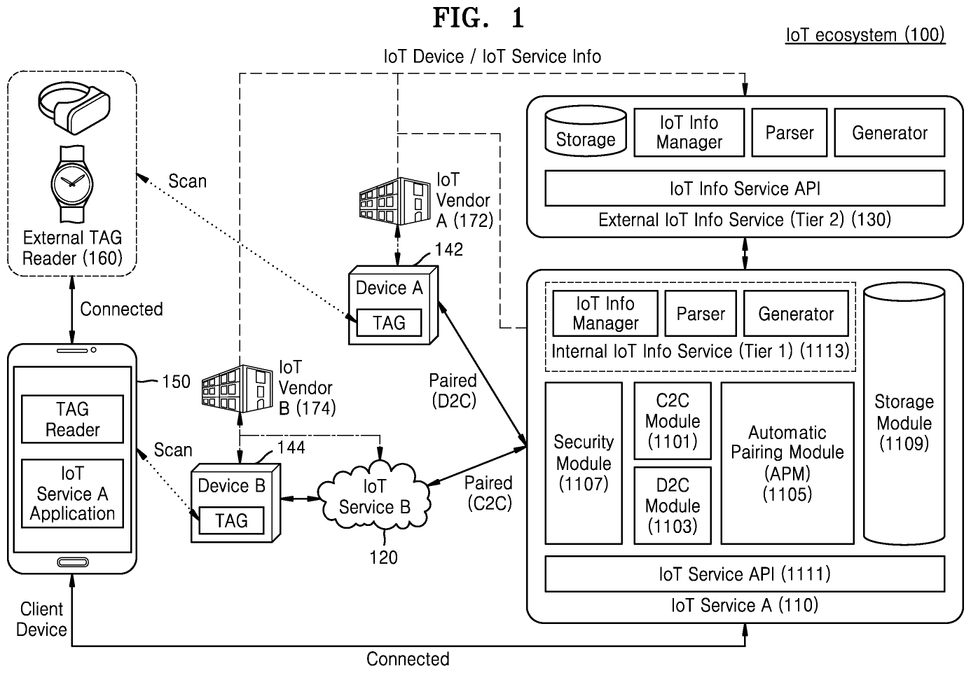

Embodiments and their advantages are best understood by reference to FIGS. 1 through 25. Accordingly, it is to be understood that the embodiments of the disclosure herein are merely illustrative of the application of the principles of the disclosure. Reference herein and the details of the illustrated embodiments are not intended to limit the scope of the claims, which themselves recite those features regarded as essential to the disclosure.

FIG. 1 is a view of an IoT ecosystem to support a C2C and/or a D2C paring mechanism according to an embodiment of the disclosure.

Referring to FIG. 1, the IoT ecosystem 100 may include various entities such as a primary IoT service entity 110, an external IoT service entity 120, an external IoT info service entity 130, at least one IoT device (for example, device A 142, device B 144), a client device 150, an external tag reader 160 and at least one IoT vendor (for example, IoT vendor A 172, IoT vendor B 174), but the entities are not limited hereto.

The primary IoT service entity 110 according to an embodiment may act as a service integrator. The primary IoT service may be a main IoT service of the IoT ecosystem 100. For example, the primary IoT service may include a web service. The primary IoT service entity 110 may include an internal IoT info service entity including an IoT information manager, a parser, a generator, a security module, a C2C module, a D2C module, an APM, a storage module and an IoT service API, but not limited hereto.

According to an embodiment, an external IoT service entity B 120 may be a third-party web service related to IoT. In addition, the External IoT Info Service 130 may be a web service that provides information about the IoT devices and/or the IoT service for the C2C or the D2C pairing process. The IoT devices 142, 144 may be devices that can be paired with at least one IoT service and/or at least one IoT device. The IoT devices 142, 144 may have tags attached to enable a pairing with the IoT service. The client device 150 may include at least one IoT service application and/or a tag reader. The IoT application may be a front-end application to manage the IoT devices and the IoT services and be capable of starting the D2C and C2C pairing. The external tag reader 160 may add or extend the capability of the client device 150 to read the tag in the IoT devices 142, 144 which may be used in the pairing process of the IoT devices 142, 144. In addition, each of the IoT vendors 172, 174 may be a developer to develop the IoT devices and/or the IoT services.

According to an embodiment, the primary IoT service entity 110 may be minimally connected to network and may include at least one of the following entities: C2C Module 1101 which manages communication between the primary IoT service and at least one external IoT service; D2C Module 1103 which manages communication between IoT devices and an IoT service; Automatic Pairing Module (APM) 1105 which generates and executes automatically the pairing procedure of D2C or C2C; Security Module 1107 which manages security related procedure (internal & external) including: authentication, authorization, and validation; Storage Module 1109 which manages the data and information related to IoT services, IoT devices, and user preferences; and IoT Service API 1111 which may provide an IoT application of the primary IoT service (i.e. mobile application or website) and may provide third party developers an access to view and manage the primary IoT service. Meanwhile, the external IoT service may be minimally connected to network and have APIs that can be used by the primary IoT service to conduct a C2C pairing and help an IoT device to pair with the external IoT device. The information about the external IoT service is available as the IoT service information which is stored in the IoT information service.

Referring now to FIG. 1, IoT Info Service (ex. Internal IoT Info Service 1113, External IoT Info Service 130) may include at least one of the followings: IoT Info Manager, which may have task to manage IoT device information and IoT service information added by the at least one IoT vendor; Storage, which may have a task to store, retrieve, and manage IoT information data; Parser, which may have task to parser the information to extract the data for the IoT Info Manager; and Generator, which may have a task to generate the IoT information, including tag information. The client device 150 may be a device capable to connect to network, use the IoT application, and read the tag in the IoT device. The client device 150 may include the following entities such as Tag Reader, which may have a task to read the tag in the IoT device; IoT Application, which may provide a user interface to do the C2C and D2C pairing process, view, and manage the IoT service and the IoT devices connected to the primary IoT Service; and External TAG Reader, which may have capability of connecting to the client device 150, read the tag in the IoT device and send the tag information to the client device 150.

In one embodiment, an electronic device, for providing an end-to-end automatic interconnection of IoT devices and systems within the heterogeneous IoT ecosystem, may include a memory configured to store one or more instructions and at least one processor configured to execute the one or more instructions to obtain pairing request to execute at least one of Cloud-to-Cloud (C2C) pairing or Device-to-Cloud (D2C) pairing, obtain pairing information comprising at least one of information about an external IoT service to pair with a primary IoT service or information about an IoT device to pair with an IoT service based on the pairing request, generate a pairing procedure model based on the pairing information and the pairing request and execute at least one of C2C pairing process between the primary IoT service and the external IoT service or D2C pairing process between the IoT service and the IoT device based on the pairing procedure. In one embodiment, the electronic device may execute user authentication of the external IoT service to authorize the primary IoT service to access and use an Application Program Interface (API) of the external IoT service based on the pairing request, execute the C2C pairing process in the primary IoT service and the external IoT service and execute the API of the external IoT service from the primary IoT service.

In one embodiment, the electronic device may enable a pairing state in the IoT device, where the IoT device can be paired with at least one of supported IoT service or supported IoT hub, obtain the pairing information including information about at least one IoT service selected by a user, execute the D2C pairing process between the IoT device and the at least one IoT service, and execute at least one function of the IoT device from the at least one IoT service.

In one embodiment, the electronic device may obtain information about an IoT hub selected by a user, transmit the pairing request of the D2C pairing to the IoT hub based on the information about the IoT hub, and execute the D2C pairing process via the IoT hub selected by the user.

In one embodiment, the electronic device may request a cloud-to-cloud (C2C) module or a device-to-cloud (D2C) module to start the C2C pairing process or the D2C pairing process according to execution of the pairing procedure.

In one embodiment, the electronic device may obtain tag information by scanning a tag of the IoT device and transmit the pairing request and the tag information to the IoT service via the IoT application.

In one embodiment, the electronic device may build a custom pairing procedure including a user defined C2C or D2C pairing procedure, obtain the pairing request to enable reading the custom pairing procedure and load and execute the custom pairing procedure in the primary IoT service.

In one embodiment, the electronic device may obtain user selection information including IoT device information about the IoT device selected to change from previous IoT service and IoT service information about the IoT service selected as new target to pair with the selected IoT device, un-pair the previous IoT service with the IoT device, enable the pairing state of the IoT device, and execute the D2C pairing between the IoT device and the selected IoT service.

The APM 1105, C2C Module 1101, D2C Module 1103, Security Module 1109, Internal IoT Info Service entity 1113 may be implemented as at least one hardware processor.

The External IoT Info Service entity 130 may be also implemented as at least one hardware processor.

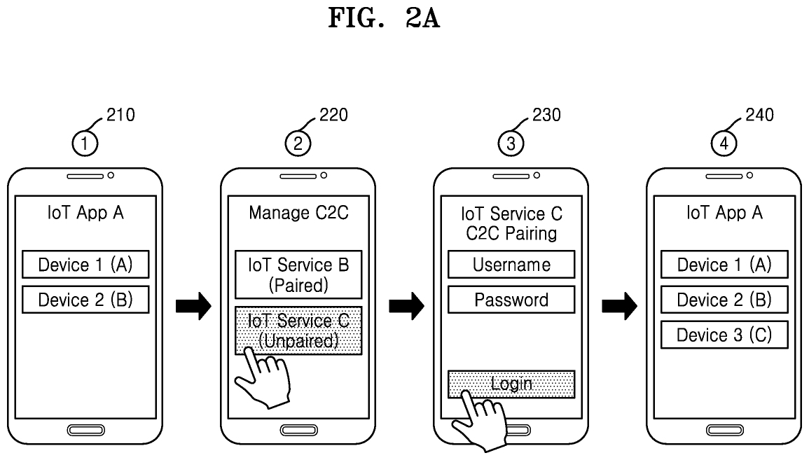

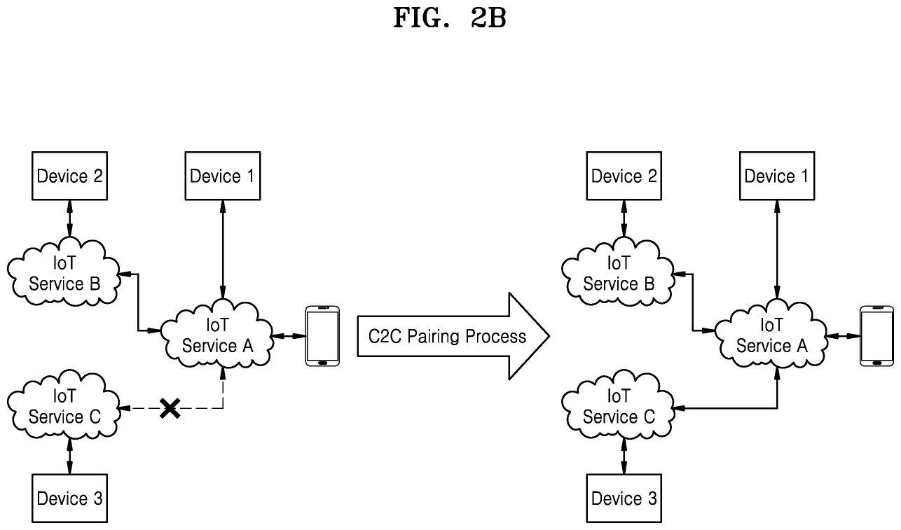

FIG. 2A illustrates an example of the C2C pairing process from the user perspective according to an embodiment of the disclosure.

FIG. 2B illustrates an example of a result of the C2C pairing process from the user perspective according to an embodiment of the disclosure.

Referring to FIGS. 2A and 2B, the C2C pairing process between IoT services from the user perspective may be performed when the user wants to pair the external IoT service with the primary IoT service. In operation 210, the user may have IoT devices connected to the external IoT service. In addition, the user may want to pair the external IoT service with the primary IoT service. In operation 220, user may select the external IoT service that is going to be paired with the primary IoT service. In operation 230, the user may authenticate himself/herself by logging in to an external IoT service authentication page. In operation 240, after the user successfully logins to the external IoT service, the primary IoT service will start a pairing process automatically with the external IoT service. After the C2C pairing process is completed, the user can now monitor and manage the IoT devices in the external IoT services from the primary IoT service, and the IoT devices will behave as the IoT devices are paired with the primary IoT service.

For example, the user may have an IoT device 1, an IoT device 2, and an IoT device 3 and the user want to pair the IoT devices with the IoT service C, which is an external IoT service. An IoT service A may be a primary IoT service. In addition, the user may select the IoT service C that is going to be paired with the IoT service A. The user may authenticate himself by login to authentication page of the IoT service C with a username and a password. However, the method of authentication is not limited hereto. After the user successfully logins to the IoT service C, the IoT Service A which is the primary IoT service will start a pairing process automatically with the IoT Service C. After the C2C pairing process is completed, the user can now monitor and manage their IoT devices in the external IoT service B and C from IoT service A, and the IoT devices will behave as those IoT devices are paired with IoT service A which is the primary IoT service.

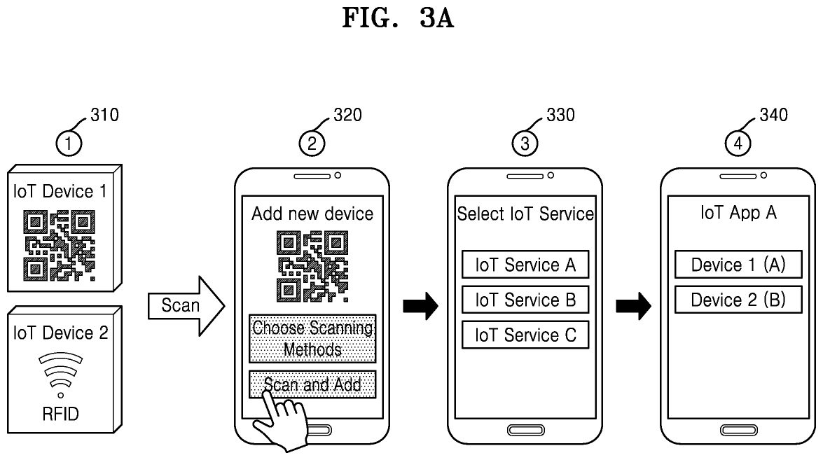

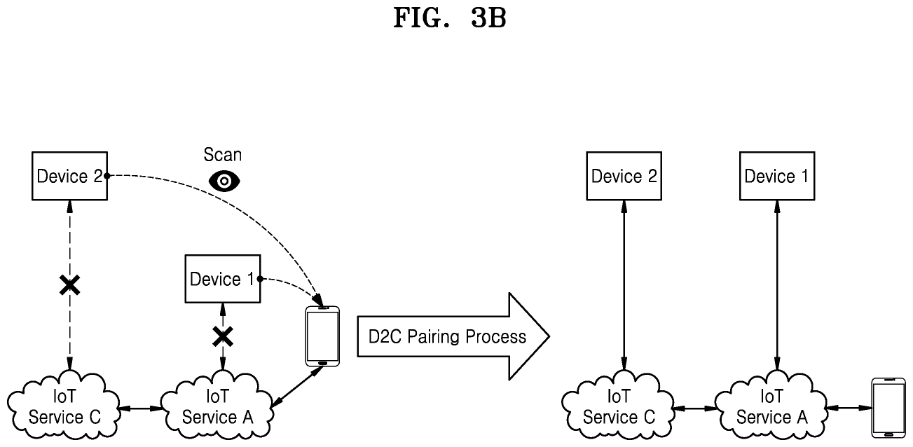

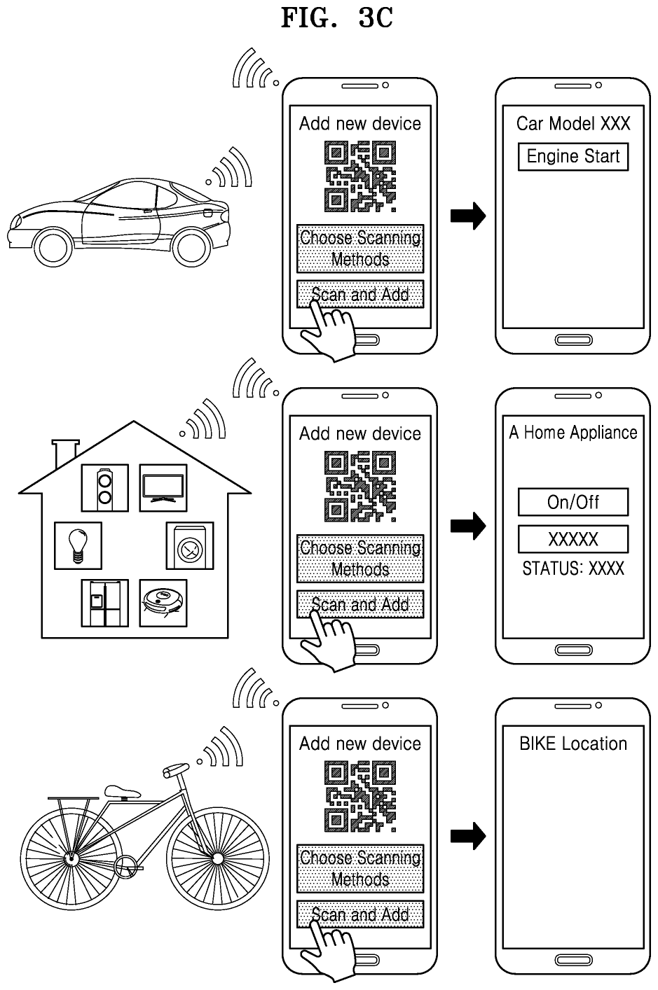

FIG. 3A illustrates the D2C paring process from the user perspective for a universal IoT paring application according to an embodiment of the disclosure.

FIG. 3B illustrates a result of the D2C paring process from the user perspective for a universal IoT paring application, according to an embodiment of the disclosure.

Referring to FIGS. 3A and 3B, the D2C pairing process from the user perspective for a universal IoT pairing application may be performed when a user wants to pair the IoT device with the IoT service. In operation 310, the user may have IoT devices with tags and the tag information for the TAG registered in the IoT information service. For example, the tag may include Quick Response code (QR code), Radio-frequency Identification (RFID), barcode and etc., but not limited hereto. In operation 320, to start pairing process, the user may scan the tag on the IoT device using a tag reader from an IoT application. In operation 330, the IoT application will display a list of IoT services that are compatible with the scanned IoT device, and then the user may select at least one IoT service the user wants to be connected with the IoT device. In operation 340, the system may start the pairing process between the IoT device and the IoT service seamlessly and automatically.

FIG. 3C illustrates examples of the D2C pairing process according to an embodiment of the disclosure.

Referring to FIG. 3C, after the D2C pairing process is completed, a user can connect IoT devices to any compatible IoT services chosen by the user. One example of a D2C use-case is pairing the new smart car with the IoT service. As an example, the user may buy a new car and want to pair the new car with the IoT service registered by the user. The user can start the engine and control the doors and windows inside the smart car via a single IoT application. Another example of the D2D use-case is pairing the smart home appliances with the IoT service. As an example, any IoT smart home device from any vendor at a home can be paired with an IoT service via the single IoT application. Another example of the D2D use-case is pairing the geo-location tracker with a smart map service. As an example, user may pair the geo-location tracker inside the bicycle with the smart map service and the user can track where the bicycle is going via the single IoT application.

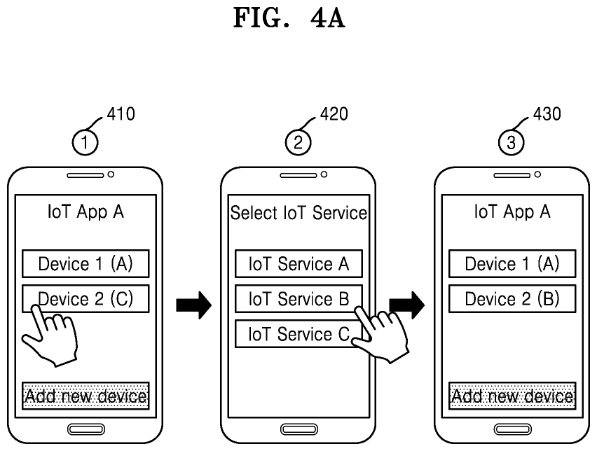

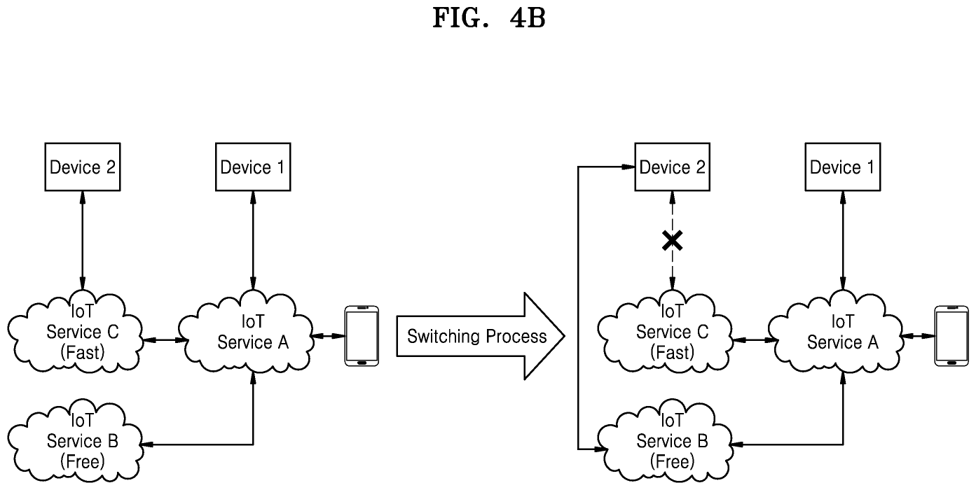

FIG. 4A illustrates a process of flexible IoT service switching, which illustrates a flow of an IoT application when a user wants to switch the IoT services according to an embodiment of the disclosure.

FIG. 4B illustrates a result of the process of the flexible IoT service switching according to an embodiment of the disclosure.

Referring to FIGS. 4A and 4B, in operation 410, a user may have at least one IoT device already connected to the IoT service regardless of the primary IoT service or the external IoT service. In operation 420, the user may decide to switch from the old IoT service to the new IoT services. The system may then display a list of the IoT services compatible with the IoT devices. The user may select the new IoT service from the list of IoT services. In operation 430, the system may then start the IoT service switching process, starting by un-pairing the IoT device with the previous IoT service and then pairing the IoT device with the new IoT service. After the process is completed, the user can monitor and manage their device as usual, with feature from the new IoT service. According to an embodiment, the cloud may make the user to switch to more favorable IoT services when the IoT services change their feature, price, policy and so on.

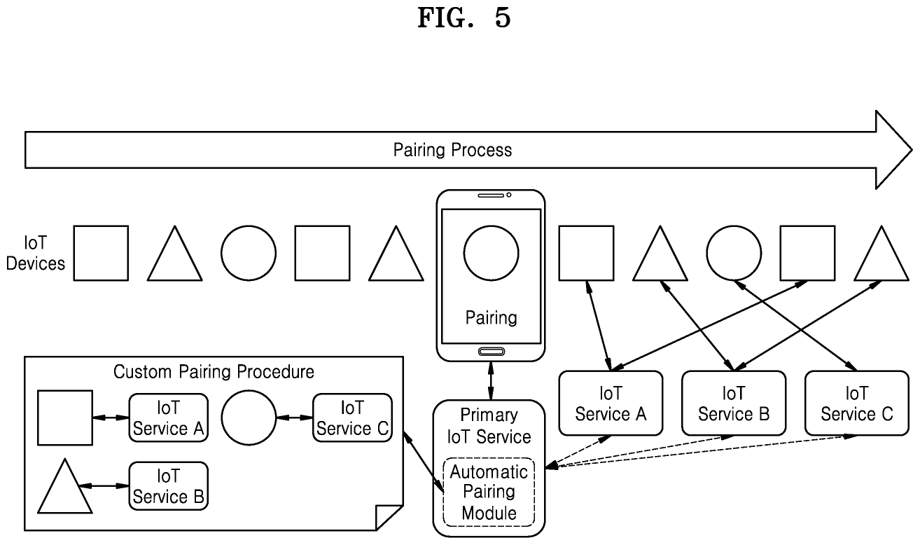

FIG. 5 illustrates a process of a mass pairing of the IoT devices using the automatic pairing manager (APM) and custom pairing procedure according to an embodiment of the disclosure.

Referring to FIG. 5, embodiments herein can be used to pair the IoT devices in the large-scale IoT ecosystem. In current technology, the pairing process is performed by manually searching the IoT device and manually selecting the IoT service for the IoT devices. According to embodiments herein, the process of pairing the IoT devices can be performed easily and automatically via a custom pairing procedure to pair the specific IoT devices with the specific IoT services as predefined. As shown in FIG. 5, the process of pairing many IoT devices with the specific IoT service is illustrated. The primary IoT service may use the custom pairing procedure to give APM a rule to pair the specific IoT device with the specific IoT service. When the IoT application starts to pair the IoT device with the IoT service, the APM will execute the custom pairing procedure and automatically select the IoT service to be paired with those IoT devices.

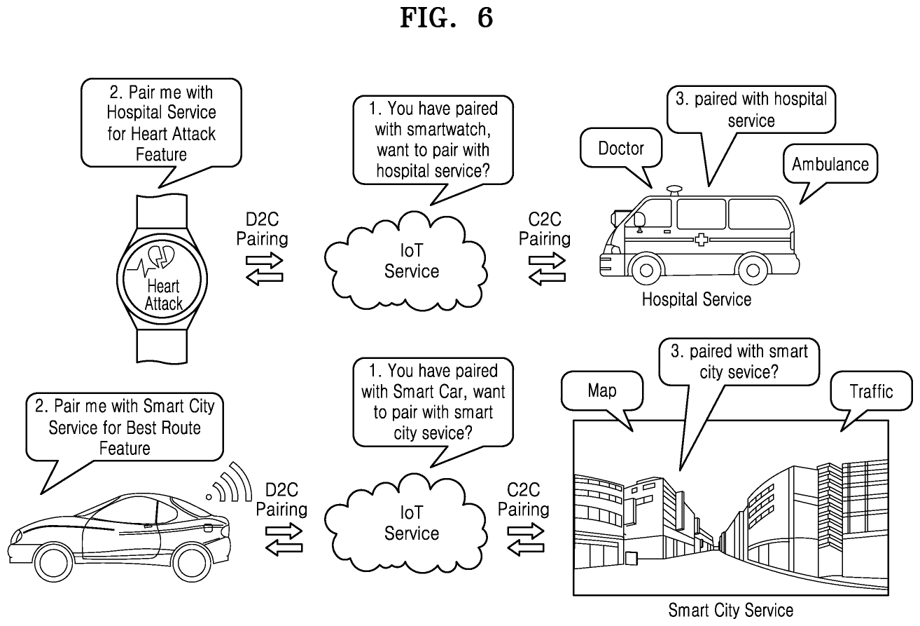

FIG. 6 illustrates a sample scenario on how to enhance functionality and capability of IoT device paired with primary IoT service using external IoT services according to an embodiment of the disclosure.

Referring to FIG. 6, the primary IoT service can give a suggestion to the user to improve the functionality and capability of the IoT device by allowing the external IoT service to be connected to primary IoT service. As illustrated in FIG. 6, if there are some IoT devices (like a smart watch or a smart car) paired with the primary IoT service, the primary IoT service will check the IoT device and suggest some external IoT services that can be paired with the primary IoT service based on the IoT device information (example: a hospital service for the smart watch or the smart city service for the smart car), so the external IoT service will improve capability and functionality of the paired IoT devices (example: the smart watch can call an ambulance in a heart attack or the smart car can go to the hospital using the best route). In one embodiment, the external IoT service is not only able to be paired with the IoT device in the D2C pairing, but also able to provide the service and the data to a third-party that uses their service.

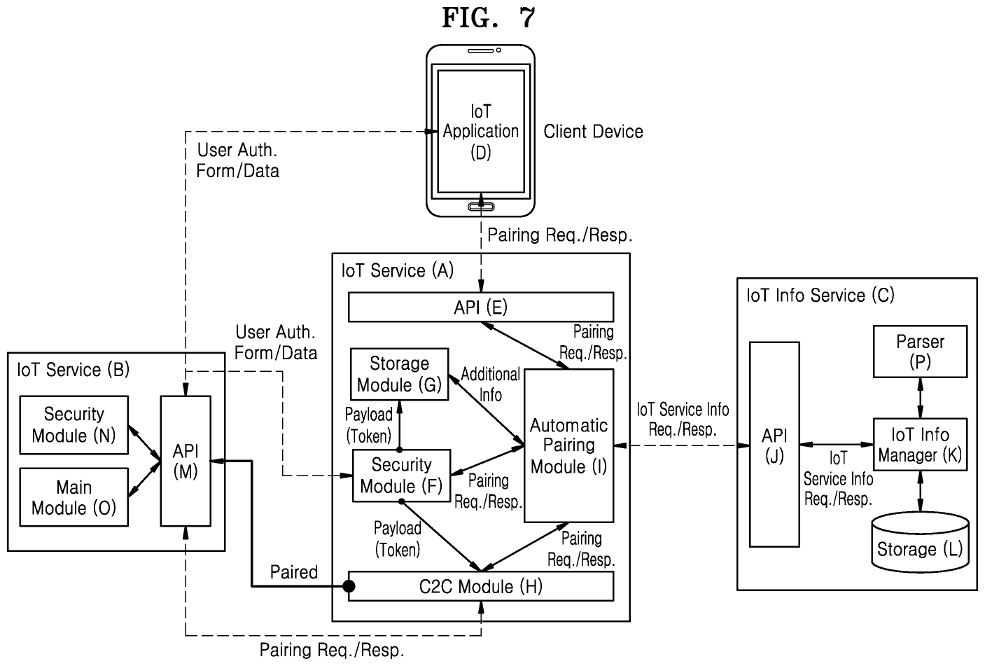

FIG. 7 illustrates a system and data required to enable the C2C pairing in the IoT ecosystem according to an embodiment of the disclosure.

Referring to FIG. 7, to enable the C2C module to communicate with the external IoT service, the primary IoT service may need to obtain authorization from the external IoT service to execute or call the Application Programming Interface (API) using the user authentication. The process from the user authentication to execute or call the API of the external IoT service may be called “pairing process.” In addition, the process of executing or calling the API of the external IoT service for un-pairing and removing the data of the un-paired external IoT service may be called “un-pairing process.” As illustrated in FIG. 7, the C2C module may have capabilities of pairing the primary IoT service with the external IoT service based on the user authentication and pairing the primary IoT service with the external IoT service automatically and customizable via the APM.

The name and the purpose of every component to support the C2C—pairing as illustrated in FIG. 7 are: a primary IoT service, an external IoT service, an IoT information service, an IoT application, an API of the primary IoT service (collections of the exposed programming interface), a security module of the primary IoT service, a storage module of the primary IoT service, a C2C module of the primary IoT service, an automatic pairing module of the primary IoT service, an API of the IoT information service, an IoT information manager of the IoT information service, a storage of the IoT information service, an API of the external IoT service, a security module of the external IoT service, a main module of the external IoT service, and a parser of the IoT information service.

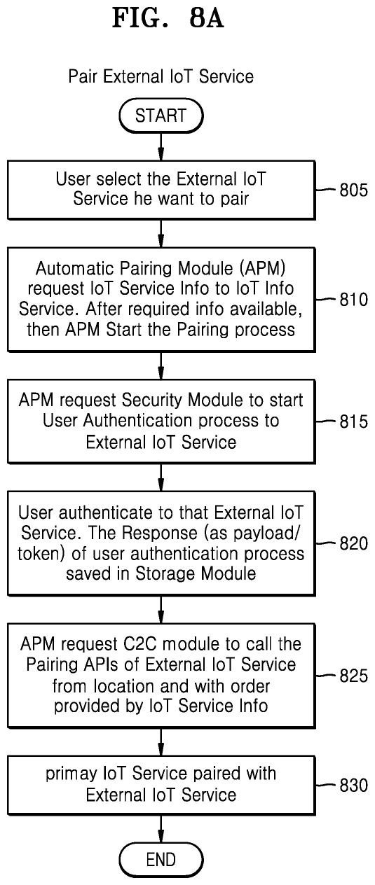

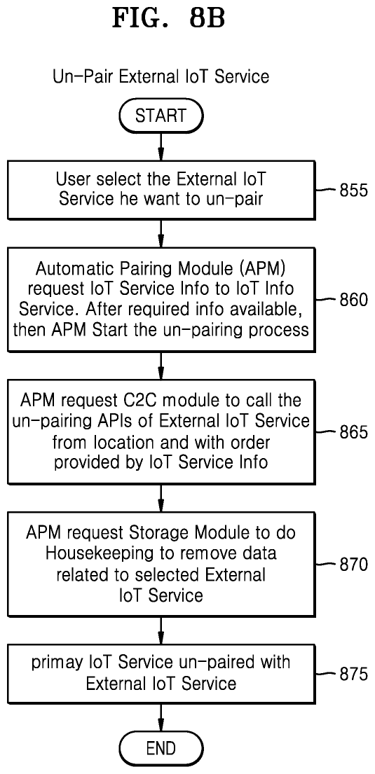

FIG. 8A is a flowchart of the C2C pairing between the primary IoT service and the external IoT service according to an embodiment of the disclosure.

Referring to FIG. 8A, in operation 805, the user may select the external IoT service that the user wants to pair with the primary IoT service. In operation 810, automatic pairing module (APM) will request the IoT service information to the IoT information service to obtain information about how and where to start pairing with the external IoT service. If the required information is available, the APM may start the pairing process. In operation 815, the APM will request the security module to start the user authentication process to the external IoT service. In operation 820, after user authenticates the external IoT service, the response (as payload/token) from the user authentication process may be saved by the storage module used by the C2C module to execute or call the C2C pairing APIs of the external IoT service. In operation 825, the APM may request the C2C module to execute or call the pairing APIs of the external IoT service from the location and with order provided by the IoT service information. In operation 830, when the primary IoT service can access and execute the API of the external IoT Service, the primary IoT service and the external IoT service are already paired each other.

FIG. 8B is a flowchart of the C2C unpairing process between the primary IoT service and the external IoT service according to an embodiment of the disclosure.

Referring to FIG. 8B, in operation 855, the user may select the external IoT service that the user wants to un-pair with the primary IoT service. In operation 860, the automatic pairing module (APM) will request the IoT service information to the IoT information service entity to obtain information about a procedure to start the un-pairing with the external IoT service. Based on the information, the APM may start the un-pairing process after the required information is available. In operation 865, the APM will request the C2C module to execute or call the un-pairing APIs of the selected external IoT service from the location and with order provided by the IoT service information. In operation 870, after the selected external IoT service gives an un-pairing confirmation, the automatic pairing module will request the storage module to do or execute housekeeping to remove the unused configuration, payload, and data related to un-paired the external IoT service. In operation 875, the primary IoT service may be un-paired with the external IoT service.

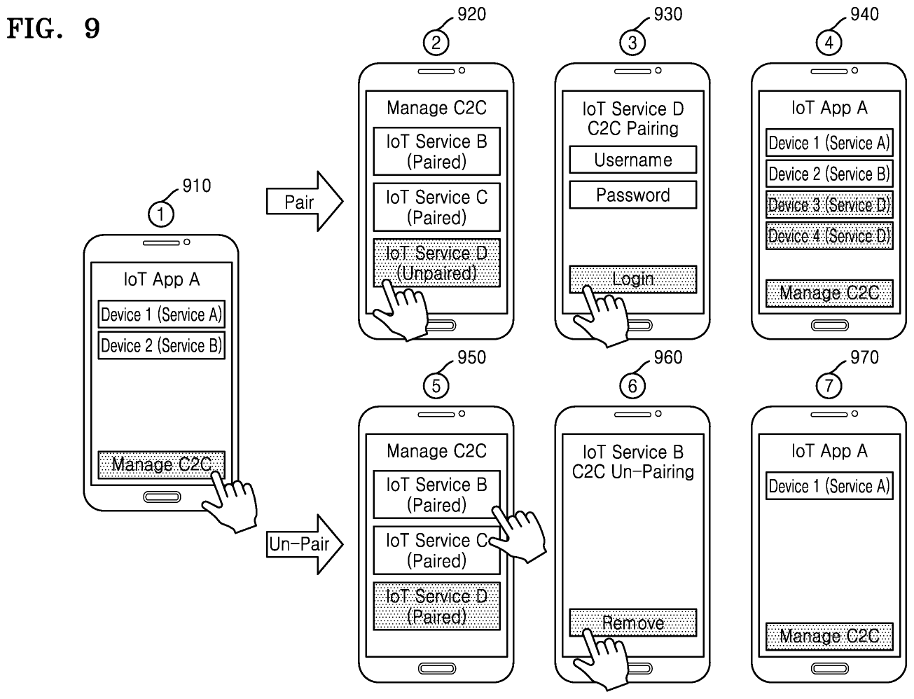

FIG. 9 illustrates the pairing and un-pairing process of the C2C module according to an embodiment of the disclosure.

Referring to FIG. 9, a flow diagram of the user interface to execute or do the C2C connection between the primary IoT service and the external IoT service is illustrated. In one embodiment, operations 910, 920, 930 and 940 may perform the pairing process of the external IoT service. In operation 910, the user may select at least one option to execute or perform the C2C pairing in the IoT application. For example, the user may select at least one option to manage the C2C pairing. In operation 920, the user may need to select the external IoT service that is not yet paired with the primary IoT service if the user wants to pair the external IoT service with the primary IoT service. For example, the user may select IoT service D which is not yet paired with the primary IoT service. In operation 930, IoT application may display the user authentication page for the selected external IoT service. In one embodiment, the user may input the user authentication information and press the login button. For example, the IoT application may display the user authentication page for the IoT service D and the user may input a user name and a password to log in to the IoT application. However, this is only one example, and the user may log in using a method other than using the user name and the password. The method of authenticating the user is not limited thereto. In operation 940, the user may identify or notice the changes in the IoT application and the system as a response to pairing the external IoT service with the primary IoT service if the user goes back to the main page of the IoT application. In one embodiment, the application can display the IoT devices from the paired external IoT service.

In another embodiment, operations 910, 950, 960 and 970 may perform the un-pairing process of the external IoT service. In operation 910, the user may select at least one option to execute or perform the C2C un-pairing in the IoT application. For example, the user may select at least one option to manage the C2C pairing. In operation 950, the user may select an external IoT service paired with the primary IoT service when the user wants to un-pair the external IoT service with the primary IoT service. For example, the user may select IoT service B which is already paired with the primary IoT service. In operation 960, the IoT application will display the page with a button for removing the IoT service in the IoT application. In addition, the user may click the remove button to continue the un-pairing process. In operation 970, if the user goes back to the main page of the IoT application, the user may identify or notice the changes in the IoT application and the system as a response of un-pairing the external IoT service with the primary IoT service. In one embodiment, the IoT application may hide the IoT devices which are paired with the external IoT service and are not paired with the primary IoT service.

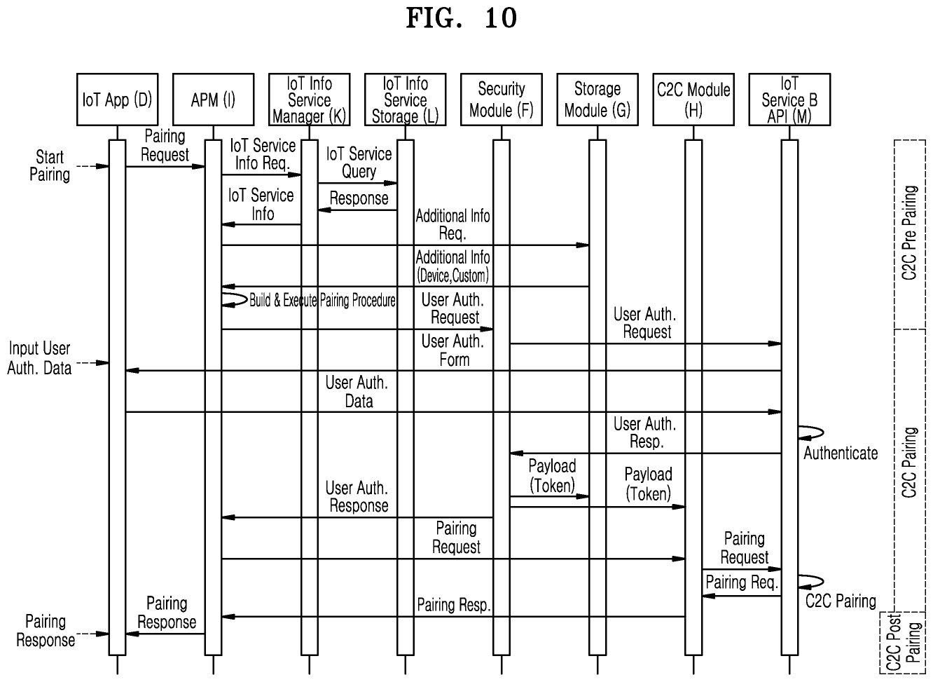

FIG. 10 illustrates a sequence diagram of the C2C pairing process according to an embodiment of the disclosure.

Referring to FIG. 10, the flow of the sequence diagram may also illustrate the relevant system, data, and the process of the C2C pairing mechanism in an IoT environment as well as its connection displayed on the user interface. In one embodiment, the IoT application (D) may send a pairing request to the APM (I) to start the pairing process between the primary IoT service (A) and the external IoT service (B). In addition, the APM (I) will request the IoT service information based on the pairing request. In one embodiment, the APM (I) may send an IoT service information request to the IoT information service manager (K). In one embodiment, the IoT information service manager (K) may request the IoT service information to the IoT information service storage (L). The IoT information service storage (L) may return the IoT service information. In addition, the APM (I) may receive the IoT service information from the IoT information service manager (K). In one embodiment, the APM (I) may request necessary additional information (ex. device information, custom procedure, etc.) to storage module (G). The storage module (G) may return the additional information. In addition, the APM (I) may start to build and execute the pairing procedure. Accordingly, the APM (I) may request the user authentication process to the external IoT service (B) via the security module (F). The security module (F) may request the user authentication to the external IoT service API (M). In one embodiment, the external IoT service API (M) may return the user authentication form to the IoT application (D), which user need to fill. In addition, the IoT application (D) may transmit the user authentication data to the external IoT service API (M). Accordingly, the external IoT service API (M) may start the authentication and the authorization process from the authentication data. In one embodiment, the external IoT service API (M) may return the user authentication response payload (token) to the security module (F) based on the received user authentication data. In addition, the security module (F) may save the user authentication response payload (token) to the storage module (G). The security module (F) may transmit the received payload (token) to the C2C module (H). In one embodiment, the APM (I) may transmit the pairing request to the C2C module (H). The C2C module (H) will execute or call the external IoT service API (M) to start the pairing process. The external IoT service API (M) may execute or perform the pairing procedure. In addition, the external IoT service API (M) will return the pairing response to the C2C module (H). The C2C module (H) will transmit the pairing response to the APM (I). The APM (I) will transmit the pairing response to the IoT application (D). Then, the primary IoT service (A) can be paired with the external IoT service (B).

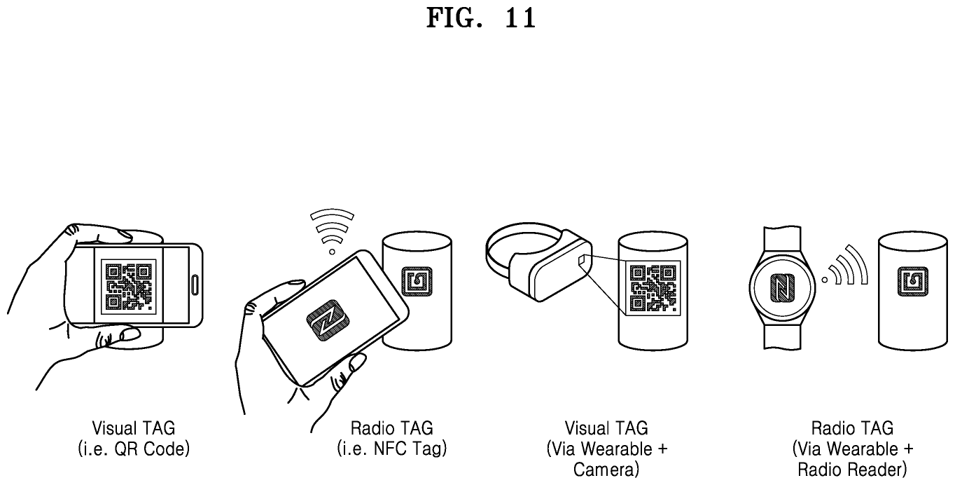

FIG. 11 illustrates an overall mechanism on how the IoT application reads the tag in the IoT device according to an embodiment of the disclosure.

Referring to FIG. 11, embodiments herein illustrate how user can scan the tag on the IoT devices. The use of the tag (visual or radio) as an identifier of the IoT device is one of the major entities in the embodiments herein to identify various heterogeneous IoT devices available in the market. The tag itself may include information to retrieve the IoT device information in the IoT information service entity. To be able to execute or perform pairing process between the IoT device and the IoT service, the client device may have an IoT application to send the tag information to the IoT service, a tag reader in the client device or the external tag reader device, and the network connection. For example, the tag may include a visual tag (ex. QR Code), a radio tag (ex. NFC TAG), and/or a tag via a wearable device, a camera, a radio reader, etc, but the tag is not limited thereto.

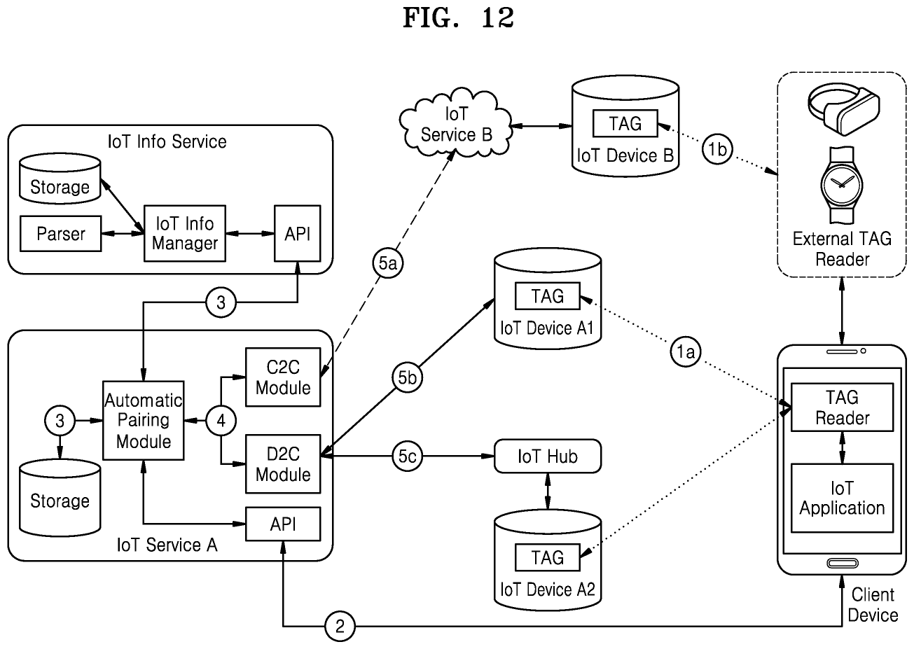

FIG. 12 illustrates how the IoT system to support the D2C pairing process according to an embodiment of the disclosure.

Referring to FIG. 12, it is illustrated how the IoT system may support the D2C pairing process, which has capability to: read the tag, obtain the IoT device information according to the tag information, create and execute the automation pairing procedure, and pair the IoT device with the external IoT service.

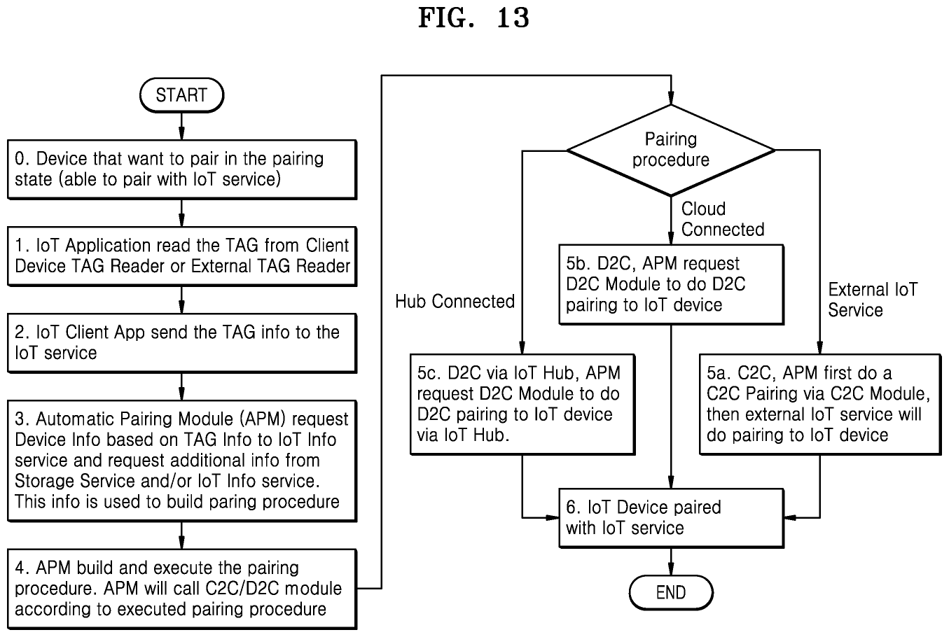

FIG. 13 is a flowchart illustrating the detailed process and the system to support the device to cloud (D2C) IoT pairing mechanism according to an embodiment of the disclosure.

Referring to FIG. 13, a user may scan the tag in the IoT device. The IoT device itself must be in the pairing state (state when the IoT device is able to be paired with the IoT service). There are 2 scenarios of scanning the tag based on the tag reader: (1) internal tag reader: The tag reader will scan the tag in the IoT device to obtain the tag information; and (2) external tag reader: The external tag reader will scan the tag in the IoT device to obtain the tag information, and send the tag information to the IoT application. The tag information and the request for the D2C pairing may be sent by the IoT application to the primary IoT service A. The primary IoT service A will process the pairing request and the tag information in the automatic pairing module (APM) to start the D2C pairing process. Information from the tag information will be used to obtain the device information in the IoT information service.

Referring to FIGS. 12 and 13, the automatic pairing module (APM) may request the IoT device information based on the tag information to the IoT information service. The APM may also request additional information like a custom pairing procedure, and the IoT service information from the storage module or the IoT information service. After receiving the IoT device information and/or the additional information, the APM will generate a pairing procedure and execute the pairing procedure to execute or call modules inside the primary IoT service. The automatic pairing module (APM) may request the C2C module or the D2C module to start the pairing process according to the execution of the pairing procedure. Based on the pairing procedure, there may be several pairing scenarios between the IoT device and the IoT services, such as: If the IoT device is paired with the external IoT service B, then the APM will first request or ask the C2C module to start the C2C pairing with the external IoT service B (if not paired yet). If the primary IoT service A is paired with the external IoT service B, then the APM will instruct the C2C module to start the pairing process between the external IoT service and the IoT device; If the IoT device is paired directly with the primary IoT service A, then the APM will instruct the D2C module to start the pairing procedure to the IoT device; If the IoT device is paired indirectly (via Hub) with the primary IoT service A, then the APM may instruct the D2C module to execute or call the paired IoT hub to execute or perform the pairing process with the IoT device. If the IoT device is already paired with the IoT service, then the user can monitor, control and manage the IoT device via the IoT application.

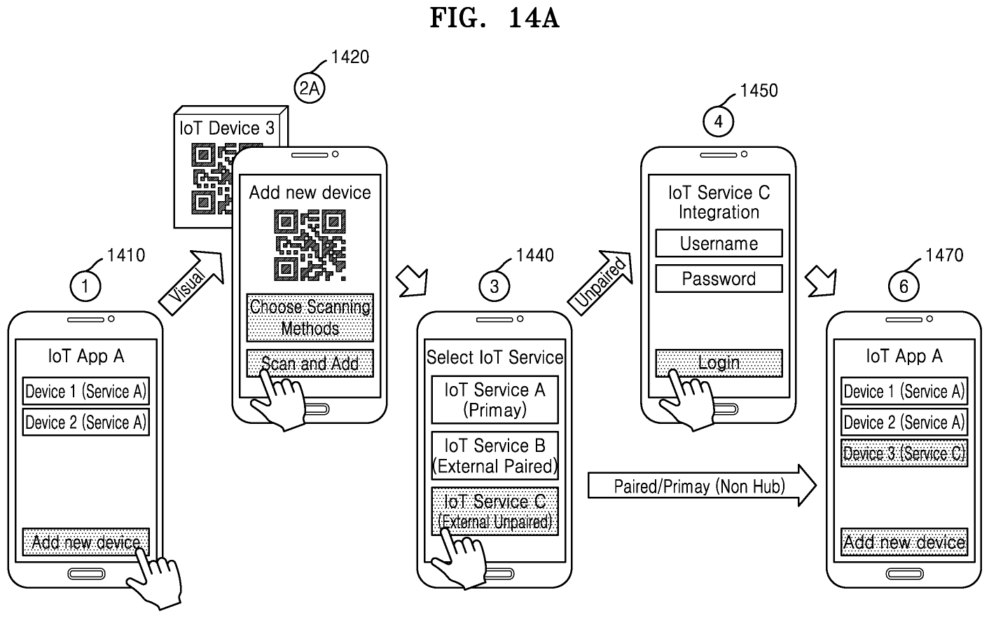

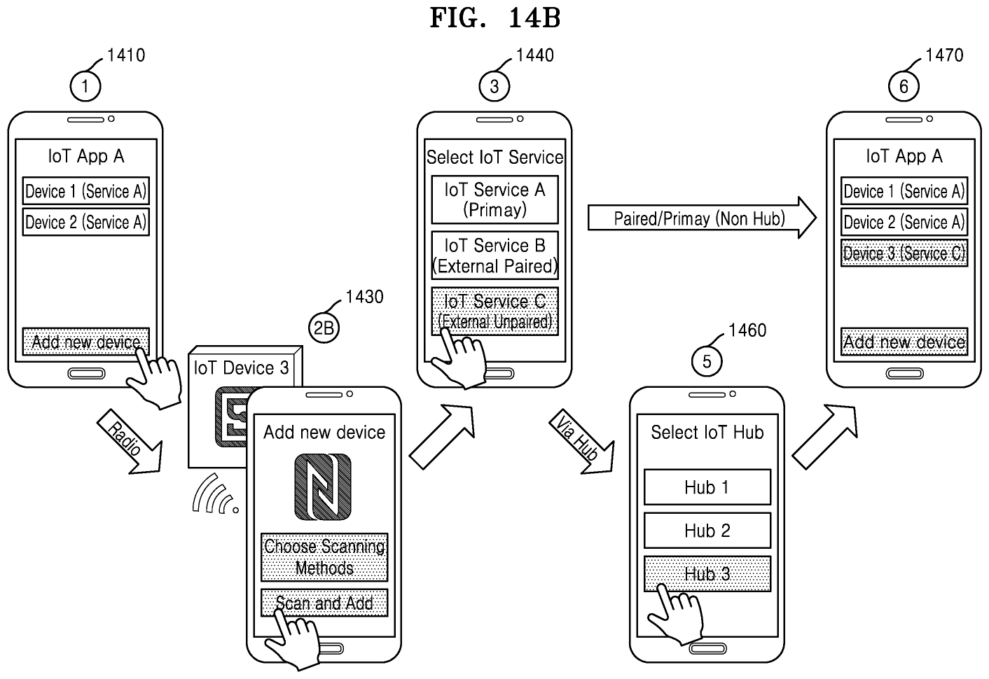

FIGS. 14A and 14B illustrate of the D2C pairing by scanning the tag which shows a flow of the user interface during the D2C pairing process according to various embodiments of the disclosure.

Referring to FIGS. 14A and 14B, in operation 1410, the user may select at least one option to add at least one new device to process the D2C pairing. In operations 1420 and 1430, the user needs to scan the tag attached to the IoT device. For example, in operation 1420, the user may scan the visual tag (ex. QR Code) attached to the IoT device. For another example, in operation 1430, the user may scan the radio tag (ex. NFC Tag) attached to the IoT device. In operation 1440, the user may select the IoT service which one the user wants to connect to the IoT devices. If the user selects the unpaired external IoT service, in operation 1450, the system may establish the C2C pairing between the external IoT services and the internal IoT service. In addition, the system will start the D2C pairing between the external IoT service and the IoT device via the C2C module after the C2C pairing process is finished. However, if the user selects the primary IoT service or the paired external IoT service, in operation 1460, the system may detect that the IoT device need to be connected to the IoT hub, then the user may select the IoT hub to which the user wants connect with the IoT device. In operation 1470, the user may go back to the main page of the IoT application. In addition, the user may identify or notice the changes in the IoT application and the system as a response to the completion of the pairing process between the IoT device and the IoT service. For example, the IoT application may show the new IoT device as a result of the D2C pairing.

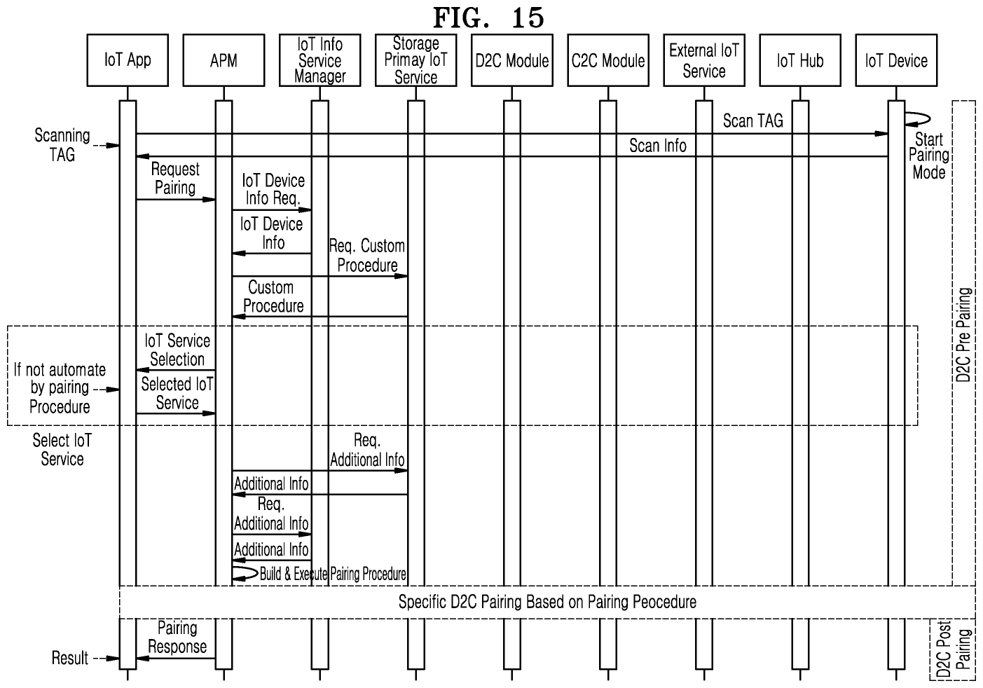

Referring to FIGS. 15 through 19, embodiments herein illustrate the detailed sequence diagram of the D2C pairing process. The detailed flow of the sequence diagram may also illustrate the relevant system, the data, and the process of the D2C pairing mechanism in an IoT environment, as well as its connection on the user interface.

FIG. 15 is a detailed sequence diagram of D2C pairing process according to an embodiment of the disclosure.

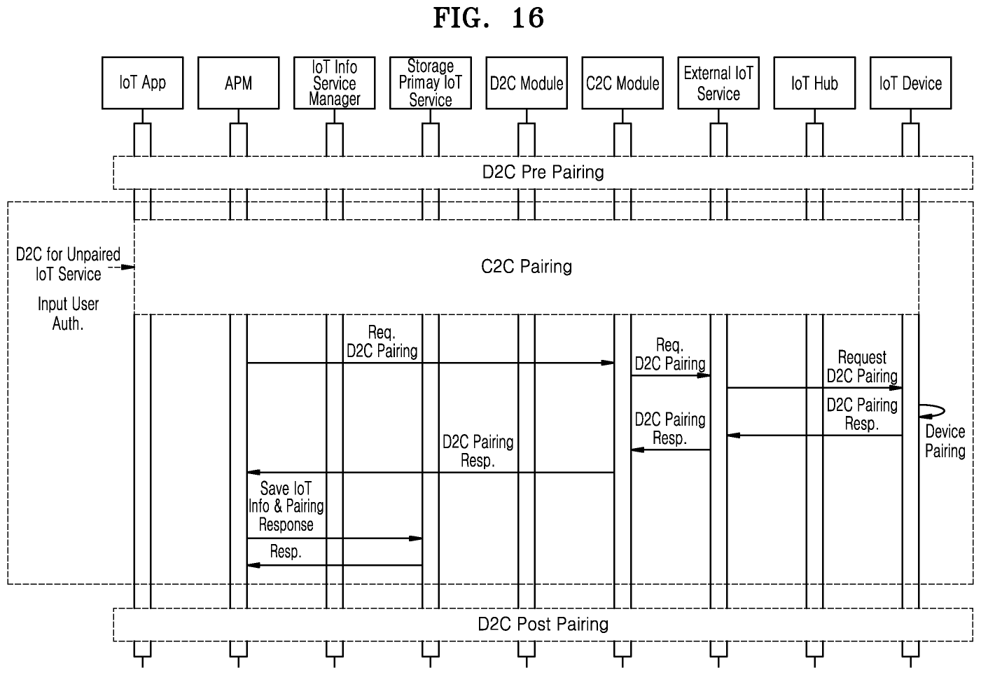

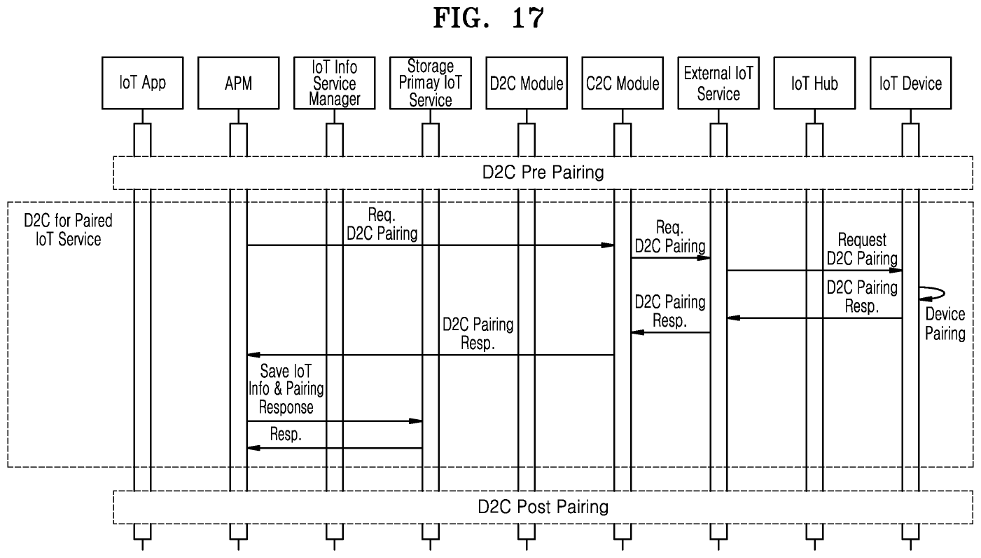

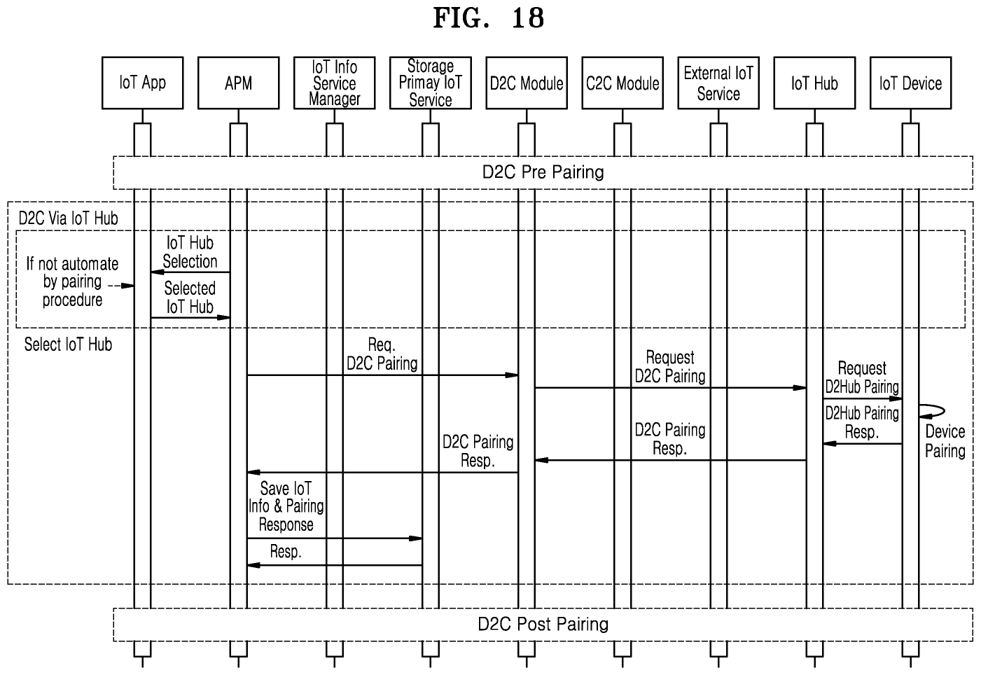

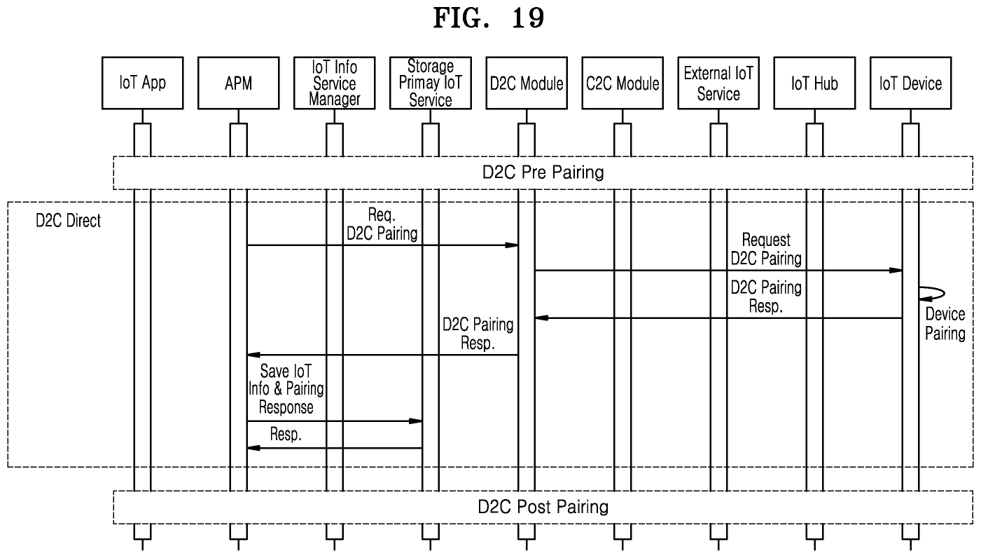

Referring to FIG. 15, the flow of the sequence diagram may also illustrate the relevant system, data, and the process of the D2C pairing mechanism in an IoT environment as well as the connection state on the user interface. In one embodiment, the user may start the pairing mode of the IoT device. The user may use the IoT application to obtain the tag information of the IoT device by scanning the tag in the IoT device. The IoT application may transmit a pairing request to the APM to start a pairing process of the IoT device. In addition, the APM will request the IoT device information according to the pairing request and the tag information. In one embodiment, the APM may transmit a request of the IoT device information (including the tag information) to the IoT information service via the IoT information service manager. The IoT information service manager will parse the tag information in the IoT information service parser and use the parsed information to request the IoT device information to the IoT information service storage. The IoT information service storage may return the IoT device information. In addition, the IoT information service manager may return the requested IoT device information to the APM. In one embodiment, the APM may request the custom pairing procedure to the primary IoT service storage if available. If the custom pairing procedure is available, the primary IoT service storage may return the custom pairing procedure to the APM. In another embodiment, if the custom pairing procedure is unavailable, the APM will give the list of the IoT services supporting the selected IoT device to the IoT application and show the list to the user. The IoT application may return the selected IoT service to the APM. In one embodiment, the APM may load several additional information (i.e. user preference) from the primary IoT service storage and/or the IoT information service to complete requirements for building the pairing procedure in the APM. The APM may build and execute the pairing procedure. In addition, the APM may instruct modules inside the primary IoT service to execute the D2C pairing based on the executed pairing procedure. There are 4 scenarios of the D2C pairing: D2C pairing for the unpaired external IoT service (FIG. 16), D2C pairing for the paired external IoT service (FIG. 17), D2C pairing via the hub to the primary IoT service (FIG. 18), and D2C pairing directly to the primary IoT service (FIG. 19). Accordingly, the APM may return the pairing response to the IoT application and the IoT device paired with the selected IoT service.

FIG. 16 is a detailed sequence diagram of the D2C pairing process for the unpaired external IoT service, according to an embodiment of the disclosure.

Referring to FIG. 16, the user and the system may execute a pre-pairing process of the D2C pairing as shown in FIG. 15. In one embodiment, the APM may instruct the C2C modules in the primary IoT service to perform or execute the C2C pairing (FIG. 10) with the selected and unpaired external IoT service. After the primary IoT service and the external IoT service are paired with each other, the APM may instruct the C2C modules to generate a D2C pairing request by calling the pairing API of the external IoT service to execute the pairing with the IoT device. The external IoT service may start a pairing process with the IoT device. In addition, the IoT device may start the pairing process with the external IoT service assisted by the IoT application. The IoT device may return the pairing response to the external IoT service. The external IoT service may return the pairing response to the primary IoT service via the C2C module. The C2C module may return the pairing response to the APM. The APM may save the pairing response to the primary IoT service storage. In one embodiment, the user and the system may execute or perform a post-pairing process of the D2C pairing as shown in FIG. 15. Then, the IoT device may be paired with the external IoT service.

FIG. 17 is a detailed sequence diagram of the D2C pairing process for the paired external IoT service according to an embodiment of the disclosure.

Referring to FIG. 17, the user and the system may perform or execute the pre-pairing process of the D2C pairing as shown in FIG. 15. In one embodiment, the APM may instruct the C2C modules in the primary IoT service to generate a D2C pairing request by calling the pairing API of the external IoT service to execute or perform pairing with the IoT device. Accordingly, the external IoT service may start the pairing process with the IoT device. In addition, the IoT device may start a pairing process with the external IoT service assisted by the IoT application. The IoT device may return the pairing response to the external IoT service. The external IoT service may return the pairing response to the primary IoT service via the C2C module. In one embodiment, the C2C module may return the pairing response to the APM. The APM may save the pairing response to the primary IoT service storage. The user and the system may perform or execute the post-pairing process of the D2C pairing as shown in FIG. 15. Accordingly, the IoT device may be paired with the external IoT service.

FIG. 18 is a detailed sequence diagram of the D2C pairing process between the IoT device and the primary IoT service via the hub according to an embodiment of the disclosure.

Referring to FIG. 18, the user and the system may execute the pre-pairing process of the D2C pairing as shown in FIG. 15. In one embodiment, if the custom pairing procedure is not available, the APM will give a list of the IoT hub supported by the selected IoT device to the IoT application and the APM may show the list to the user. In another embodiment, the selection of the IoT hub may be conducted automatically. The user may select the IoT hub used for pairing from the list at the IoT application, the IoT application may return the selected IoT hub to the APM. In addition, the APM may instruct the D2C modules in the primary IoT service to generate the D2C pairing request by calling the pairing API of the IoT hub to execute the pairing with the IoT device. In one embodiment, the IoT hub may start the pairing process with the IoT device. The IoT device may start the pairing process with the IoT hub assisted by the IoT application. In addition, the IoT device may return the pairing response to the IoT hub, and then the IoT Hub may return the pairing response to the primary IoT service via the D2C module. The D2C module may return the pairing response to the APM. In one embodiment, the APM may store the pairing response to the primary IoT service storage. The user and the system may execute the post-pairing process of the D2C pairing as shown in FIG. 15. Accordingly, the IoT device may be paired with the primary IoT service via the IoT hub.

FIG. 19 is a detailed sequence diagram of the D2C pairing process between the IoT device and the primary IoT service via the hub according to an embodiment of the disclosure.

Referring to FIG. 19, the user and the system may execute or do pre-pairing process of the D2C pairing as shown in FIG. 15. In one embodiment, the APM may instruct the D2C modules in the primary IoT service to generate the D2C pairing request. The D2C modules may start the pairing process with the IoT device. In addition, the IoT device may start the pairing process with the primary IoT service via the D2C module assisted by the IoT application. The IoT device may return the pairing response to the primary IoT service via the D2C module. The D2C module may return the pairing response to the APM. In one embodiment, the APM may store the pairing response to the primary IoT service storage. The user and the system may execute or perform post-pairing process of the D2C pairing as shown in FIG. 15. Accordingly, the IoT device may be paired with the primary IoT service.

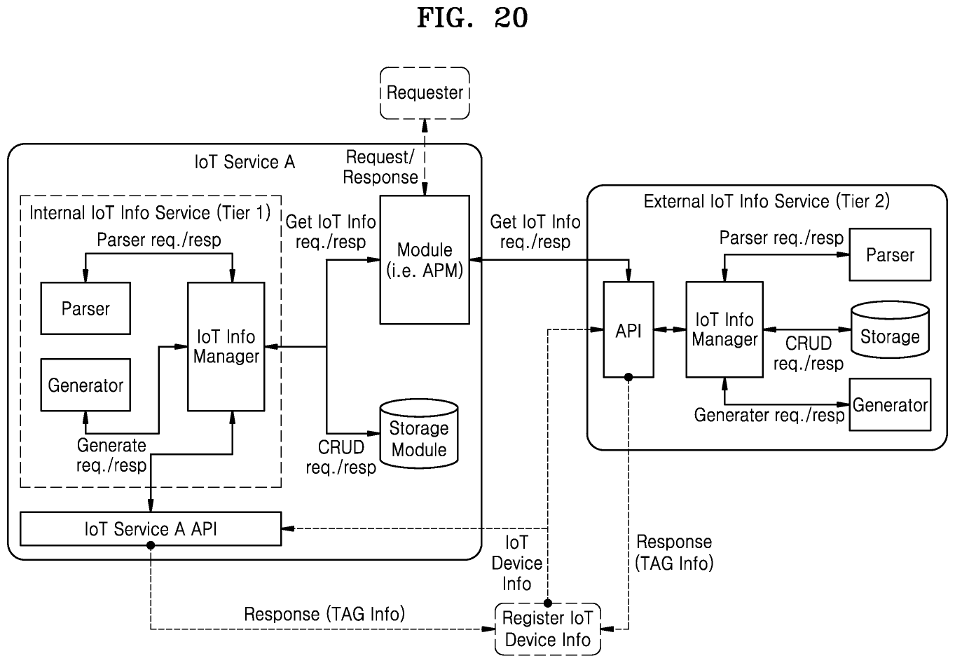

FIG. 20 is a block diagram illustrating the IoT information service system and the tiers in the IoT ecosystem according to an embodiment of the disclosure.

Referring to FIG. 20, the IoT information service may be used to retrieve or store the IoT device information and/or IoT service information used by the primary IoT service. The component of the IoT information service and its connection to the primary IoT service may include: an IoT Info Manager which is a module to register, retrieve, and manage the data inside the IoT information service; a Storage Module which is a module to load and store the tag information, the IoT device information, and the IoT service information; a Parser which is a module to parse the information to extract the data that can be understand by the IoT Info Manager; a Generator which is a module to generate the information, including the tag information from the device information; and an API which is an interface to communicate with another IoT entities.

As illustrated in FIG. 20, to make the IoT device information available in the IoT information service, the IoT vendors may need to register their IoT device information into the IoT information service. The step may be divided into the 2 categories: register the IoT device information for the existing tag information (Step 1, 2, 3) and register the IoT device without the tag information (Step 1, 4, 5).

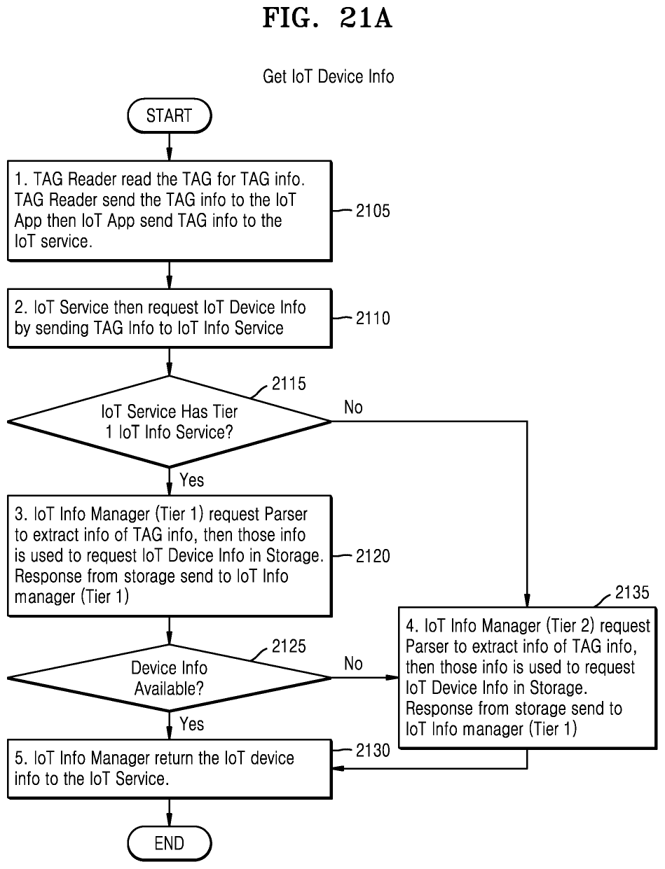

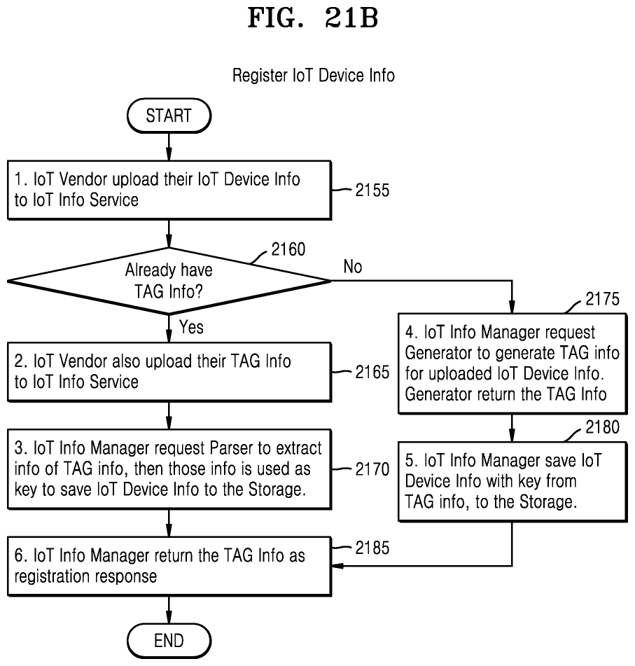

FIG. 21A is a flow diagram of obtaining the IoT device information according to an embodiment of the disclosure.

Referring to FIG. 21A, in operation 2105, the tag reader may read the tag for the tag information. The tag reader may transmit the tag information to the IoT application. The IoT application may transmit the tag information to the IoT service. In operation 2110, the IoT service may request the IoT device information by transmitting the tag information to the IoT information service. In operation 2115, the system may detect whether the IoT service has the tier 1 IoT information service.

In one embodiment, if the IoT service has the tier 1 IoT information service, in operation 2120, the IoT information manager may request the parser to extract the information of the tag information. The information may be used to request the IoT device information in the storage. The response from the storage may be transmitted to the IoT information manager. In operation 2125, the system may check whether the device information is available. If the device information is available, the IoT information manager may return the IoT device information to the IoT service in operation 2130. However, if the device information is unavailable, the IoT information manager may request the parser to extract the tag information. The information may be used to request the IoT device information in the storage in operation 2135. In addition, the response from the storage may be transmitted to the IoT information manager.

In another embodiment, if the IoT service does not have the tier 1 IoT information service, in operation 2135, the IoT information manager may request the parser to extract the tag information. The information may be used to request the IoT device information in the storage. The response from the storage may be transmitted to the IoT information manager. In operation 2130, the IoT information manager may return the IoT device information to the IoT service.

FIG. 21B is a flowchart of registering the IoT device information according to an embodiment of the disclosure.

Referring to FIG. 21B, in operation 2155, the IoT vendors may upload their IoT device information to the IoT information service. In operation 2160, the system may check or identify whether the IoT information service already has the tag information. In one embodiment, the IoT vendors may also upload the tag information to the IoT information service in operation 2165 when the IoT information service already has the tag information. In operation 2170, the IoT information manager may request the parser to extract the tag information. The information may be used as a key to save the IoT device information to the storage. In operation 2185, the IoT information manager may return the tag information as a registration response.

In another embodiment, the IoT information manager may request the generator to generate the tag information for uploading the IoT device information in operation 2175 if there is no tag information. In addition, generator may return the tag information. In operation 2180, the IoT information manager may store or save the IoT device information with the key from the tag information, to the storage. In operation 2185, the IoT information manager may return the tag information as the registration response.

Referring to FIGS. 21A and 21B, there are two tiers of the IoT information service to provide the information about the IoT device information and/or the IoT service information. To perform the pairing, the primary IoT service should be connected with at least one IoT information service.

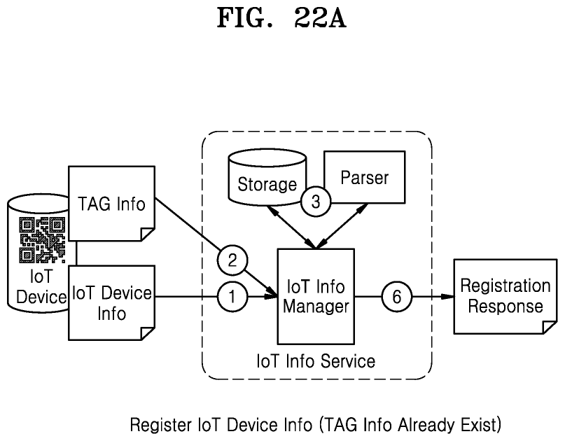

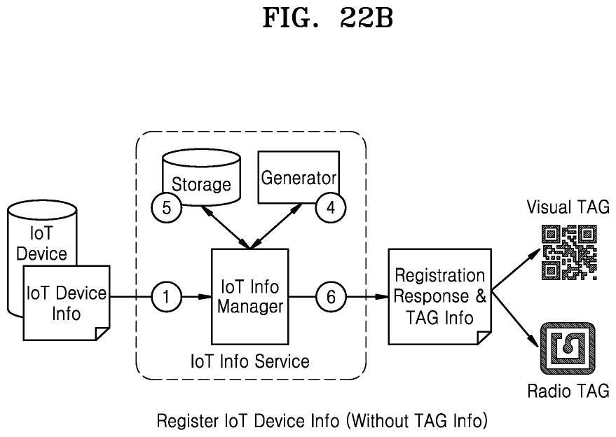

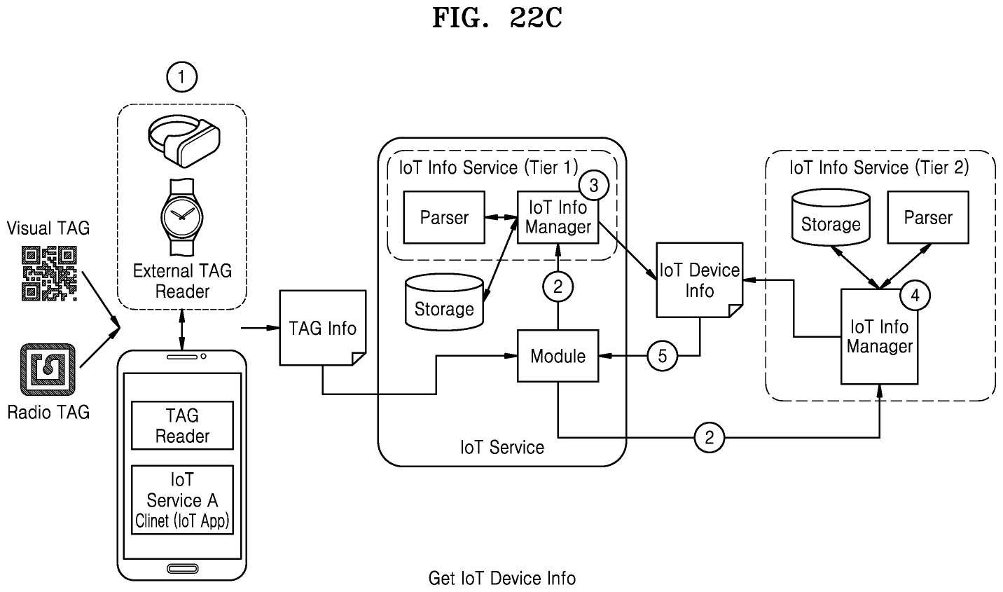

FIG. 22A is a block diagram of a process of registering the IoT device information when the tag information already exists according to an embodiment of the disclosure.

FIG. 22B is a block diagram of a process of registering the IoT device information without the tag information according to an embodiment of the disclosure.

FIG. 22C is a block diagram of a process to obtain the IoT device information according to an embodiment of the disclosure.

The tier category of the IoT information service as disclosed in FIGS. 20 through 22C may be the tier 1, called the internal IoT information service and may be an IoT information service used internally in the IoT service. The service may be usually used to retrieve the device information of the own-made device or the supported external IoT services. If there are no available devices in the tier 1 or if the tier 1 is not available, then the IoT service should go to the tier 2 of the IoT information service. While the tier 2, called the external IoT information service, is an IoT information service that may share the information with other IoT services.

Referring to FIGS. 20 through 22C, embodiments herein may disclose the step by step process to register the IoT device information of the IoT device. To execute the D2C pairing, the APM may need the IoT device information from the IoT information service. The IoT device information can be retrieved by sending the tag information to the IoT information service. The followings are step by step process to register the IoT device information: the IoT venders may upload their IoT device information into the IoT information service; If the IoT vendors have the tag information of their IoT device, then the IoT vendors can upload the tag information to the IoT information service via the IoT information manager; the IoT information manager may request the parser to parse the tag information, and use the parsed information as a key information to save the IoT device information into the storage; If the IoT vendors do not have the tag information of the IoT device, the IoT information manager will request the generator to build the tag information for the uploaded device information; If the IoT information manager requests the generator to build the tag information for the uploaded device information when the IoT vendors do not have the tag information of the IoT device, the IoT information manager may request the storage to store or save the IoT device information with the key information from the generated tag information; the IoT information manager may receive a registration response from the storage and the tag information from the generator. In addition, the registration response and the tag information will be transmitted to the IoT vendor via the IoT information manager.

Referring to FIGS. 20 through 22C, embodiments herein may disclose the step-by-step process of obtaining the device information of the scanned IoT device as follows: the IoT application may scan the tag from the IoT device, and IoT application may transmit the tag information to the primary IoT service; the primary IoT service via its module (i.e. APM) will request the IoT device information to the IoT information service. The primary IoT service may first check whether the primary IoT service has the IoT information service (tier 1); If the IoT information service (tier 1) is available, the primary IoT service may instruct the IoT information manager (tier 1) to get the IoT device information. The IoT information manager (tier 1) may request the parser to extract the key information from the tag information. The key information may be used to request the IoT device information in the storage. The response from the storage may be transmitted to the IoT information manager (tier 1). If the IoT information service (tier 1) is unavailable, the primary IoT service may instruct the IoT information manager (tier 2) to obtain the IoT device information. The IoT information manager (tier 2) may request the parser to extract the key information from the tag information, the key information may be used to request the IoT device information in the storage. The response from the storage may be sent to the IoT information manager (tier 2); the IoT information manager may return the IoT device information to the primary IoT service.

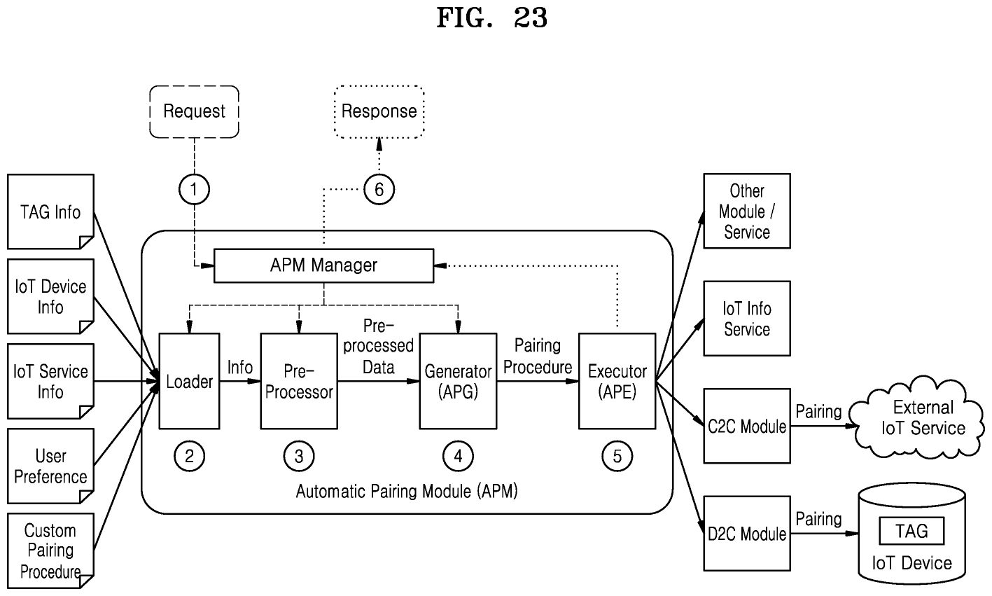

FIG. 23 is a block diagram illustrating the APM system to perform the D2C or C2C pairing, to automate the pairing process between the IoT device and the IoT service according to an embodiment of the disclosure.

Referring to FIG. 23, the APM will generate and execute the pairing procedure in which a model to represent how the pairing process should be done. The pairing procedure may include device/service configuration, pairing protocol, pairing rules, and additional information necessary for the pairing process but is not limited thereto. The data that can be used by the APM to generate the pairing procedure are: the tag information which is information about the tag; the IoT device information which is information of the device including capabilities, a supported protocol, and a supported IoT service; IoT service information which is information of the IoT service including capabilities, a pairing method and procedure, a supported protocol, and supported external IoT services; the user preference which is information set by user including, devices configuration, service configuration, user configuration, and network configuration; and the custom pairing procedure which is the custom procedure set by user for specific cases.

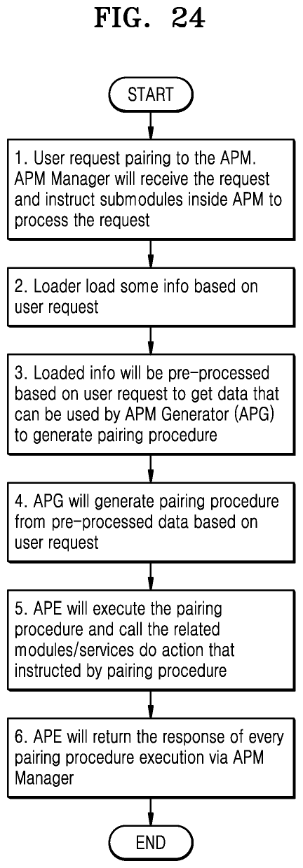

FIG. 24 is a flowchart of the automatic pairing flow to perform the D2C or C2C pairing according to an embodiment of the disclosure.

Referring to FIG. 24, embodiments herein may illustrate process of generating the pairing procedure and executing the pairing procedure to process the D2C or C2C pairing. The detailed processes how the APM works to automate the pairing process are: the APM may obtain a request from the user to execute the pairing. The APM manager will receive the request and instruct an loader, a pre-processor, and an APG (automatic pairing generator) submodule to create the pairing procedure based on the request of the user; based on the request of the user, the APM may request the loader submodule to obtain and read the tag information, the IoT device information, the IoT service Information, the user preference and/or the custom pairing procedure from their respective source; based on the user request, the APM may do pre-processing in the pre-processor submodule to merge the several collected information, to remove unnecessary data from the information, and to parse and convert the previous processed information into the data that can be understand by the automatic pairing generator (APG); Based on user request, APM will generate pairing procedure via the automatic pairing generator (APG). The APG will create the model (pairing procedure) from the data that can be executed by the automatic pairing executor (APE); the automatic pairing executor (APE) will execute the pairing procedure received from the APG. The APE will execute or call the module/service and execute the procedure instructed by the pairing procedure. The automatic pairing executor (APE) will return the response of every pairing procedure execution to the user via the APM manager. The manager, the loader, the pre-processor, the generator and the executor may be implemented as at least one hardware processor. The at least one hardware processor may be the processor 2510 in an embodiment.

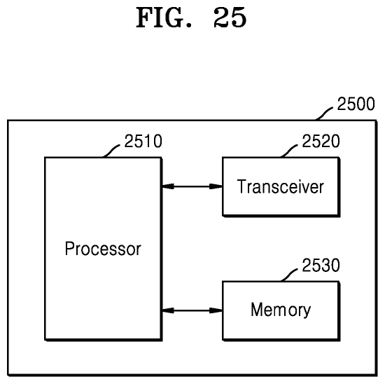

FIG. 25 is a block diagram of an electronic apparatus according to an embodiment of the disclosure.

Referring to FIG. 25, an electronic apparatus 2500 may include a processor 2510, a transceiver 2520 and a memory 2530. However, all of the illustrated components are not essential. The electronic apparatus 2500 may be implemented by more or less components than those illustrated in FIG. 25. In addition, the processor 2510 and the transceiver 2520 and the memory 2530 may be implemented as a single chip according to another embodiment. The aforementioned components will now be described in detail.

The processor 2510 may include one or more processors or other processing devices that control the proposed function, process, and/or method. Operation of the electronic apparatus 2500 may be implemented by the processor 2510. In one embodiment, the processor 2510 may receive a pairing request to execute at least one of cloud-to-cloud (C2C) pairing or device-to-cloud (D2C) pairing. In addition, the processor 2510 may obtain pairing information comprising at least one of information about an external IoT service or information about an IoT device based on the pairing request. The processor 2510 may generate a pairing procedure based on the pairing information and the pairing request and execute the at least one of the C2C pairing between the primary IoT service and the external IoT service or the D2C pairing between the IoT service and the IoT device based on the pairing procedure.

The transmitter 2520 may be connected to the processor 2510 and transmit and/or receive a signal. The signal may include control information and/or data. For example, the transceiver 2520 may receive the signal through a wireless channel and output the signal to the processor 2510. The transceiver 2520 may transmit a signal output from the processor 2510 through the wireless channel.

The memory 2530 may store the control information and/or the data included in a signal obtained by the electronic apparatus 2500. The memory 2530 may be connected to the processor 2510 and store at least one instruction or a protocol or a parameter for the proposed function, process, and/or method. The memory 2530 may include read-only memory (ROM) and/or random access memory (RAM) and/or hard disk and/or CD-ROM and/or DVD and/or other storage devices.

The embodiments of the disclosure may be embodied as a computer-readable recording medium, e.g., a program module to be executed in computers, which includes computer-readable instructions. The computer-readable recording medium may include any usable medium that may be accessed by computers, volatile and non-volatile medium, and detachable and non-detachable medium. Also, the computer-readable recording medium may include a computer storage medium and a communication medium. The computer storage medium includes all volatile and non-volatile media, and detachable and non-detachable media which are technically implemented to store information including computer-readable instructions, data structures, program modules or other data.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus for pairing among devices and services, the electronic apparatus comprising:
a memory configured to store one or more instructions; and
at least one processor configured to execute the one or more instructions to:
receive a pairing request to execute at least one of cloud-to-cloud (C2C) pairing or device-to-cloud (D2C) pairing,
obtain pairing information comprising at least one of information about an external Internet of things (IoT) service or information about an IoT device based on the pairing request,
generate a pairing procedure based on the pairing information and the pairing request, and
execute the at least one of the C2C pairing between a primary IoT service and the external IoT service or the D2C pairing between the IoT service and the IoT device based on the pairing procedure.

2. The electronic apparatus of claim 1, wherein, to execute the at least of the C2C pairing or the D2C pairing, the at least one processor is further configured to execute the one or more instructions to:
obtain a user selection of the external IoT service,
perform user authentication of the external IoT service to authorize the primary IoT service to access and use an API (Application Program Interface) of the external IoT service based on the pairing request, and
execute the C2C pairing in the primary IoT service and the external IoT service, and executing the API of the external IoT service from the primary IoT service,
wherein the pairing request comprises information about the external IoT service to execute the C2C pairing.

3. The electronic apparatus of claim 1,
wherein, to execute the at least of the C2C pairing or the D2C pairing, the at least one processor is further configured to execute the one or more instructions to:
obtain a user selection of the IoT device,
activate a pairing state in the IoT device, wherein the IoT device is to be paired with at least one of IoT service or IoT hub,
obtain the pairing information comprising information about at least one IoT service selected by a user of the electronic apparatus,
execute the D2C pairing process between the IoT device and the at least one IoT service, and
execute at least one function of the IoT device from the at least one IoT service,
wherein the pairing request comprises information about the IoT device to execute the D2C pairing, and
wherein the at least one IoT service supports the D2C pairing with the IoT device.

4. The electronic apparatus of claim 3,
wherein the at least one processor is further configured to:
obtain information about an IoT hub selected by a user of the electronic apparatus,
transmit the pairing request of the D2C pairing to the IoT hub based on the information about the IoT hub, and
receive a pairing response of the D2C pairing from the IoT hub according to the pairing request, and
wherein the executing the at least one of the C2C pairing or the D2C pairing comprises executing the D2C pairing process via the IoT hub selected by the user.

5. The electronic apparatus of claim 1,
wherein the at least one processor is further configured to request a C2C module to start the C2C pairing or a D2C module to start the D2C pairing based on execution of the pairing procedure, and
wherein the pairing procedure comprises at least one of pairing procedure between the IoT device and the primary IoT service, pairing procedure between the IoT device and a paired external IoT service, pairing procedure between the IoT device and an unpaired external IoT service, or pairing procedure between the IoT devices and the IoT service via IoT hub.

6. The electronic apparatus of claim 1,
wherein the pairing procedure comprises pairing procedure between the IoT device and the IoT service, and
wherein the at least one processor is further configured to:
obtain tag information by scanning tag of the IoT device, and
transmit the pairing request and the tag information to the IoT service via an IoT application.

7. The electronic apparatus of claim 1,
wherein the pairing procedure comprises automatic C2C pairing or automatic D2C pairing using preset configuration,
wherein the generating the pairing procedure comprises generating a custom pairing procedure comprising a user defined C2C or D2C pairing procedure, and
wherein at the least one processor is further configured to:
obtain the pairing request to enable reading the custom pairing procedure, and
load and execute the custom pairing procedure in the primary IoT service.

8. The electronic apparatus of claim 1,
wherein the pairing procedure comprises flexible IoT service switching,
wherein the at least one processor is further configured to:
obtain user selection information comprising IoT device information about the IoT device selected to change from previous IoT service and IoT service information about the IoT service selected as new target to pair with the selected IoT device, and
un-pair the previous IoT service with the IoT device, and
wherein the executing of the at least one of the C2C pairing or the D2C pairing comprises activating a pairing state of the IoT device and executing the D2C pairing between the IoT device and the selected IoT service.

9. The electronic apparatus of claim 1, further comprising:
a manager configured to:
receive the pairing request, manage an automatic pairing process in a submodule, and
return an automatic pairing process response;
a loader configured to collect data comprising at least one of tag information, IoT device information, IoT service information, information about user preference, or information about a custom pairing procedure;
a pre-processor configured to:
filter unnecessary data from the data from the loader,
transform the data, and
parse the data to be understood by a generator, the generator being configured to generate a model of the pairing procedure based on pre-processed data from the pre-processor; and
an executor configured to execute and give instruction to perform an action based on the pairing procedure.

10. The electronic apparatus of claim 9,
wherein the tag information comprises key information about an identity of the IoT device embedded in the tag to retrieve the IoT device information from the IoT information service,
wherein the IoT device information comprises detail information comprising at least one of identification of IoT device, capabilities of the IoT device, protocols of the D2C pairing, a supported IoT service, or an IoT device pairing procedure,
wherein the IoT service information comprises detail information comprising at least one of identification of IoT service, capabilities of the IoT service, protocols of the C2C pairing or the D2C pairing, an API, a supported external IoT service, a security procedure, or an IoT service pairing procedure, and
wherein the information about user preference comprises information comprising at least one of a user device, a user service, identification of user, security, or network configurations.

11. A method of an electronic apparatus, the method comprising:
receiving a pairing request to execute at least one of cloud-to-cloud (C2C) pairing or device-to-cloud (D2C) pairing;
obtaining pairing information comprising at least one of information about an external Internet of things (IoT) service or information about an IoT device based on the pairing request;
generating a pairing procedure based on the pairing information and the pairing request; and
executing at least one of the C2C pairing between a primary IoT service and the external IoT service or the D2C pairing between the IoT service and the IoT device based on the pairing procedure.

12. The method of claim 11, further comprising:
obtaining a user selection of the external IoT service; and
performing user authentication of the external IoT service to authorize the primary IoT service to access and use an Application Program Interface (API) of the external IoT service based on the pairing request,
wherein the executing at least one of C2C pairing or D2C pairing comprises:
executing the C2C pairing in the primary IoT service and the external IoT service, and
executing the API of the external IoT service from the primary IoT service, and
wherein the pairing request comprises information about the external IoT service to execute the C2C pairing.

13. The method of claim 11, further comprising:
obtaining a user selection of the IoT device;
enabling a pairing state in the IoT device, wherein the IoT device can be paired with at least one of IoT service or IoT hub;
obtaining the pairing information comprising information about at least one IoT service selected by a user; and
executing at least one function of the IoT device from the at least one IoT service,
wherein the executing at least one of C2C pairing or D2C pairing comprises executing the D2C pairing process between the IoT device and the at least one IoT service,
wherein the pairing request comprises information about the IoT device to execute the D2C pairing, and
wherein the at least one IoT service supports the D2C pairing with the IoT device.

14. The method of claim 11, further comprising:
obtain information about an IoT hub selected by a user of the electronic apparatus;
transmitting the pairing request of the D2C pairing to the IoT hub based on the information about the IoT hub;
receiving a pairing response of the D2C pairing from the IoT hub according to the pairing request; and
executing the D2C pairing via the IoT hub selected by the user.

15. The method of claim 11, further comprising:
requesting a C2C module to start the C2C pairing or a D2C module to start the D2C pairing based on execution of the pairing procedure,
wherein the pairing procedure comprises at least one of pairing procedure between the IoT device and the primary IoT service, pairing procedure between the IoT device and a paired external IoT service, pairing procedure between the IoT device and an unpaired external IoT service, or pairing procedure between the IoT devices and the IoT service via IoT hub.

16. The method of claim 11, further comprising:
obtaining tag information by scanning tag of the IoT device; and
transmitting the pairing request and the tag information to the IoT service via an IoT application,
wherein the pairing procedure comprises pairing the IoT device with the IoT service.

17. The method of claim 11, further comprising:
generating a custom pairing procedure comprising a user defined C2C or D2C pairing procedure;
obtaining the pairing request to enable reading the custom pairing procedure; and
loading and executing the custom pairing procedure in the primary IoT service,
wherein the pairing procedure comprises automatic C2C pairing or automatic D2C pairing using preset configuration.

18. The method of claim 11, further comprising:
obtaining user selection information comprising IoT device information about the IoT device selected to change from previous IoT service and IoT service information about the IoT service selected as new target to pair with the selected IoT device;
un-pairing the previous IoT service with the IoT device;
activating a pairing state of the IoT device; and
executing the D2C pairing between the IoT device and the selected IoT service,
wherein the pairing procedure comprises flexible IoT service switching.

19. The method of claim 11, further comprising:
receiving, by a manager, the pairing request;
managing, by the manager, an automatic pairing process in a submodule;
returning, by the manager, an automatic pairing process response;
collecting, by a loader, data comprising at least one of tag information, the IoT device information, the IoT service information, the information about user preference, or the information about a custom pairing procedure;
filtering, by a pre-processor, unnecessary data from the data from the loader;
transforming and parsing the data to be understood by a generator;
generating, by the generator, the pairing procedure based on the pre-processed data from the pre-processor; and
executing, by an executor, instruction to do action based on the pairing procedure.

20. A computer program product comprising a non-transitory computer readable recording medium having recorded thereon a plurality of instructions, which when executed by at least one processor, causes the at least one processor to:
receive a pairing request to execute at least one of cloud-to-cloud (C2C) pairing or device-to-cloud (D2C) pairing;
obtain pairing information comprising at least one of information about an external Internet of things (IoT) service or information about an IoT device based on the pairing request;
generate a pairing procedure based on the pairing information and the pairing request; and
execute at least one of the C2C pairing between a primary IoT service and the external IoT service or the D2C pairing between the IoT service and the IoT device based on the pairing procedure.
